(19) United States
(12) Patent Application Publication
(10) Pub. No.: US 2025/0236980 A1
(43) Pub. Date: Jul. 24, 2025

(54) REDOX FLOW LITHIUM EXTRACTION SYSTEMS AND METHODS OF USE THEREOF

(71) Applicant: Storagenergy Technologies, Inc., Salt Lake City, UT (US)

(72) Inventors: Feng Zhao, Salt Lake City, UT (US); Yuyue Zhao, Murray City, UT (US); Weilin Zhang, Salt Lake City, UT (US); Ivy Zhao, Salt Lake City, UT (US)

(21) Appl. No.: 18/418,024

(22) Filed: Jan. 19, 2024

(51) Int. Cl. C25C 7/06; C25C 1/02; C25C 7/04

(52) U.S. Cl. CPC C25C 7/06; B01D 61/463; C25C 1/02; C25C 7/04

(57) ABSTRACT

Described are Redox Flow Lithium Extraction (RFLE) technologies for fast, high-purity lithium obtention in the forms of LiCl, LiOH, Li₂CO₃, and lithium metal from geothermal seawater or brine or other lithium sources. The RFLE cells described herein are multi-component systems utilizing Li⁺ ion conducting solid-state electrolyte (LiCSSE) membranes and anion exchange membranes (AEMs) within arrangements of flow cells continually supplied with redox shuttle molecules (RSM) to maintain charge balance within the system. The described systems and methods therefore achieve a continuously flowing system for obtaining high-purity lithium from diverse lithium sources. Relatively high lithium extraction rates are obtained through these described systems and methods with relatively low cost and high longevity compared with existing and legacy technologies. The systems and methods described herein provide an environmentally low impact solution for lithium extraction.

### BACKGROUND

Overuse of fossil fuels as a major energy source has resulted in critical challenges such as limited resources, pollution, increasing carbon emissions, and the resulting climate crisis. Social concern has catalyzed a transition to, and heightened interest in, carbon-neutral energies in both transportation and grid sectors. The development of lithium-ion batteries (LIBs) for use in electric vehicles (EV) and stationary storage has raised an urgent need for an increase in lithium production. While spodumene minerals (LiAlSi₂O₆) are a major source for global commercial lithium production, brine resources account for 70% to 80% of the U.S. lithium deposits. (See, U.S. Department of Energy, “Battery Critical Materials Supply Chain Challenges and Opportunities,” DOE/EE-2535, December, 2021). Therefore, the domestic lithium obtention in the U.S. will necessarily look to rely heavily on lithium-rich brines in the immediate and near future. The estimated lithium resources found in California's Salton Sea region geothermal fluids alone exceeds the current U.S. demand for lithium. (See, Ventura et al., “Selective Recovery of Lithium from Geothermal Brines,” California Energy Commission, CEC-500-2020-020, March, 2020). Geothermal brines have great potential to be developed into a robust lithium supply but still remain a commercially untapped source due to technical challenges.

Lithium is a key constituent of lithium-ion batteries (LIBs) that are used in several applications, particularly in consumer electronics, electric vehicles (EVs), and energy storage systems (ESSs). The global drive for clean energy and transportation has initiated a jump in sales of EVs and ESSs and is expected to accelerate it further. This will cause an increase in demand for lithium (Li), mainly as two battery-grade Li-based chemicals: lithium carbonate (Li₂CO₃) and lithium hydroxide (LiOH·H₂O). Lithium is also important for other sectors, including in ceramics, glass, pharmaceuticals, polymers, metallurgy, and aerospace. Given such significance, Li remains on a list of critical materials whose sustained, reliable supply over the next few decades is important for both the economy and security.

Globally, lithium is found in three types of deposits: brines, hard rock deposits (or pegmatite deposits), and sedimentary deposits (clay). The major commercial sources of these deposits are located outside the United States-Saline brines (such as those in Chile) that collectively account for 50 to 75% of global lithium production, and hard rock deposits in Australia and China. However, lithium production from these sources has been known to fluctuate over the years for a variety of reasons. This, along with the supply chain issues during the CoVID-19 crisis and the critical importance of lithium, has generated concern about the likelihood of lithium shortages in the future and its resultant negative effects on the economy. It has also sharpened the focus on exploring opportunities for production of lithium.

Compared to its extraction from saline (Salar) brines and hard rock deposits, lithium production from these brines has lower land and water demands, is less carbon-intensive via use of geothermal energy for plant operation, and involves less turnaround time for lithium supply. Also, after lithium extraction, the lithium-barren brine is returned back to the reservoir, thereby addressing environmental and social concerns associated with brine evaporation in case of saline (Salar) brines. Estimates suggest that geothermal brine-based lithium production lowers land requirement by a factor of about 10,000 over evaporation-based projects for the same amount of lithium produced. Lithium production from both geothermal and non-geothermal brines involves the use of reserves that are being used for other economic purposes, meaning that these are brownfield investments that may not incur high costs for investors.

Geothermal brines refer to hot, concentrated saline solutions that flow through hot rocks and are used to generate electricity via geothermal power plants. These brines mostly made of water, while also being rich in major elements and minerals such as potassium, arsenic, boron, silica, and most critically, lithium. The extraction of these elements and minerals from geothermal brines is useful as it provides alternative sources of their supply, as well as important in order to avoid their harmful impacts on geothermal power plant components. Examples of such harmful impacts are corrosion of power plant equipment and scaling inside pipes that can damage this equipment and reduce its heat transfer efficiency.

Conventionally, lithium is extracted from Salar brines through evaporative concentration, where brine water is evaporated using solar radiation, and the left-over concentrate is processed to obtain lithium. However, lithium extraction from both geothermal and non-geothermal brines utilizes a different group of technologies, collectively termed direct lithium extraction (DLE). Direct lithium extraction from brines, without the use of evaporative ponds, may result in less land disturbance and less water use if the brine is extracted from deep aquifers that are disconnected from fresh water aquifers, surface waters, and vegetation.

In the DLE process/technology, initially, fresh brine (or brine obtained after geothermal power generation) is withdrawn from the reservoir and processed chemically to selectively strip Li-containing material from it. The Li-containing material is subsequently processed further in multiple steps to produce the final Li-chemical (Li₂CO₃, LiCl, lithium metal, and/or LiOH). The residual spent brine (after recovering the Li-containing material from it) is reinjected back into the brine using injection wells. The use of DLE technology for brines is beneficial compared to evaporative concentration on multiple counts. Evaporative concentration requires the brines to contain extremely high amounts of lithium (>>2,000 mg/kg), limiting its applicability for most brines with much lower Li content (60-600 mg/kg) for which DLE can be used. Further, evaporative concentration can only be used in specific geographies and climatic regions that receive abundant sunshine and less rainfall over any time horizon, since a large amount of time is needed to extract the desired lithium (typically many months). In contrast, DLE processes can be used to extract lithium from brines in a matter of hours. Also, in case of Salar brines, almost all of the water from the brine is lost to evaporation, raising concerns. However, DLE technology offers the option to re-inject the spent brine back into the reservoir, thus reducing these concerns. DLE comprises a variety of technologies and techniques, including precipitation, sorption, ion-exchange, solvent separation/extraction, membranes (membrane separation), and electrochemical separation technologies.

Thus, technologies available for commercial lithium production from Salar brines and spodumene minerals require energy-intensive, costly, time- and resource-consuming procedures for lithium concentration, impurity removal, and product purification. (See, A. Chagnes & J. Swiatowska, (Eds.), “Lithium process chemistry: Resources, extraction, batteries, and recycling,” Elsevier Science Publishing, 2015). For instance, Direct Lithium Extraction (DLE), including adsorption, ion exchange, and solvent extraction, exploits selective adsorbents to separate out lithium and represents the latest trend for lithium obtention, potentially providing faster production and less environmental impact than legacy methods. However, DLE technologies have not been tested at large scales and over long periods of time. Thus, the practical techno-economic analyses (TEA) are still to be determined. This knowledge gap has left ample space for other DLE approaches to be developed. For instance, electrochemical methods are an emerging strategy for extraction of lithium, usually in a product form of LiCl. Electrodialysis (ED) and capacitive deionization (CDI) both use an electric field to separate Li⁺ and Cl⁻ from other brine ions, but the product purity is largely impaired by limited ion selectivity. (See, Zavahir et al., Desalination, 500, ARTN 114883, doi:10.1016/j.desal.2020.114883, 2021). More recently, aqueous stable lithium ion battery cathodes such as olivine LiFePO₄ and spinel LiMn₂O₄ have been explored for use in collecting Li⁺ via selective intercalation; however, such approaches appear to have substantial limitations in Li⁺ selectivity, extraction rate, extraction capacity, materials stability, and/or operational consistency. (See, Battistel et al., Adv. Mater, 32, ARTN 1905440, doi:10.1002/adma.201905440, 2020).

To overcome these technical drawbacks currently existing in the field of DLE, described hereinbelow are Redox Flow Lithium Extraction (RFLE) methods, systems, and technologies aiming at achieving energy-saving, fast-rate, high-purity lithium obtention. Because of its differentiated cell design, the disclosed RFLE methods are well poised to address the aforementioned technical issues of legacy DLE methods. The RFLE cells described herein are multi-component systems utilizing ion-selective and superconductive membranes of advanced materials within flow cells continually supplied with redox active reagents through a continuous circulating redox shuttle. The described systems and methods therefore provide a continuously flowing system for obtaining high-purity lithium from diverse raw materials sources such as geothermal brine or seawater. These described systems and methods achieve these results while utilizing a very low amount of energy. Relatively high lithium extraction rates are obtainable through these described systems and methods with relatively low cost and high longevity. Finally, the systems and methods described herein provide an environmentally low impact solution to the lithium extraction problem facing the economy.

The limited available lithium production and refining capacities have posed critical challenges for sustaining battery supply chains, deploying more clean energy technologies, and mitigating the climate crisis. Improved lithium production capacity from currently untapped geothermal brines will expand lithium supply from diversified sources and reduce the risk of supply chain disruption. The advantages of low energy input and high energy efficiency will lead to the use of less electricity, reduction in energy cost, and mitigation of carbon emission. Therefore, the technology described herein is expected to have potential to enhance energy resilience, sustainability, and security that will assist the establishment of a clean, decarbonized economy.

### SUMMARY

Provided are systems and methods for environmentally low-impact, low energy, continuous, and high purity extraction of lithium from diverse liquid sources such as geothermal brine and seawater. Lithium obtained by these systems and methods is in the form of one or more of LiCl, LiOH, Li₂CO₃, and solid lithium metal. The systems are multicomponent comprising several flow cells, one or more redox shuttle systems, optional fluid pumps and holding tanks, selective anion exchange membranes (AEMs), and lithium ion conducting solid-state electrolyte (LiCSSE) membranes, all fluidly connected together in a closed or open system that is liquid-tight to prevent leakage at any stage. The RFLE cells or stacks described herein utilize lithium ion-conducting solid state membranes within flow cells continually supplied with redox active reagents through a continuous circulating redox shuttle.

The redox flow lithium extraction systems described herein comprise LiCSSE membranes, anion exchange membranes (AEMs), and flow cells arranged in a system. The flow cells comprise in one embodiment at least a catholyte flow cell, an analyte flow cell, a lithium base flow cell, and a brine water flow cell. The lithium base flow cell and brine water flow cell are fluidly connected by the LiCSSE membrane that lies between these two flow cells in a water-tight manner, and the lithium base flow cell is fluidly connected to an anolyte flow cell by one of the AEMs in a similar manner.

In one embodiment of such systems, a brine water (geothermal brine, raw material lithium source water) flow cell is fluidly connected to a catholyte flow cell by another one of the AEMs, there being two AEMs in this embodiment of the system. In the described RFLE systems, the catholyte flow cell and the anolyte flow cell are fluidly connected to one another by one or more fluid channels such that a fluid is carried from one to the other in a circulating and continuous manner, optionally pushed along by one or more in-line pumps, and interconnected with one or more holding tanks.

In the described RFLE systems, the catholyte flow cell and the anolyte flow cell each comprise an electrode. In the described RFLE systems, the LiCSSE membrane is positioned between the two AEMs within the system, the lithium base flow cell comprises an first inlet allowing a flow of lithium base fluid into the lithium base flow cell and an first outlet allowing an outflow of lithium-rich product from the lithium base flow cell, and the brine water flow cell comprise an second inlet allowing a flow of sea water or brine into the flow cell and an second outlet allowing an outflow of the lithium-rich product. In some embodiments, the catholyte cell and/or the anolyte cell comprise an interdigitated flow field.

In the described RFLE systems, lithium ions pass through the LiCSSE membrane from the brine water flow cell and into the lithium base flow cell, chloride ions pass through a first one of the AEMs from the brine water flow cell into the catholyte flow cell, and chloride ions pass through a second one of the AEMs from the anolyte flow cell into the lithium base flow cell. In some embodiments, the LiCSSE membrane is a laser-etched membrane. In other embodiments, the LiCSSE membrane further comprises one or more dopants.

In such systems, the one or more fluid channels comprise a fluid comprising a redox shuttle molecule (RSM), where the RSM undergoes oxidation and reduction in the catholyte and anolyte flow cells. That is, the redox shuttle molecule yields a loss of electrons in the catholyte flow cell, and anions are conducted into catholyte through AEM to balance the loss of electrons as well; and the redox shuttle molecules yield a gain of electrons, and anions are conducted into lithium base flow cell through AEM in the redox shuttle molecule and chloride ions in the anolyte flow cell chemically react with the redox shuttle molecule to yield a gain of electrons in the redox shuttle molecule.

In certain embodiments, the redox shuttle molecule is an organometallic molecule, or a (ferrocenylmethyl) trimethylammonium chloride (FcNCl) molecule or any combination thereof. In other embodiments, the redox shuttle molecule comprises 1,1′-bis[3-(trimethylammonio)propyl]ferrocene dichloride (BTMAP-Fc). In certain embodiments, the LiCSSE membrane comprises one or more of: (i) Li_{1.3}Al_{0.3}Ti_{1.7}(PO₄)₃ (LATP), Li_{1+y}Zr₂(SiO₄)_{y}(PO4)_{3-y} (LYTP), Li₃Zr_{2-y}Si_{2-4y}P_{1+4y}O₁₂ (LZSP), Li₁₊ₓYₓZr₁₋ₓ(PO₄)₃ (LYZP), Li_{1+x+y}Y_{X}Zr₂₋ₓ(SiO₄)_{y}(PO₄)_{3-y} (LYZSP), (Li₁₊ₓAl_{y}Ge_{2-y}(PO₄)₃ (LAGP), Li_{1.5}Al_{0.5}Ge_{1.5}(PO₄)₃, and Li_{3.1}Zr_{1.95}Mg_{0.05}Si₂PO₁₂, (ii) Li₃ₓA_{2/3-x}BO₃, wherein A is La, Na, K, Ca, Sr, or Ba, and wherein B is Ti, Sc, In, Al, Sm, Ga, Ti, Zr, Hf, Sn, Ge, Nb, or Ta, (iii) Li₇₋ₓMₓLa₃Zr₂O₁₂, wherein M is Al, Ga, Fe, or Ge, (iv) Li₇La₃₋ₓEₓZr₂O₁₂ wherein E is Sr or Y, (v) Li₇La₃Zr₂₋ₓJₓO₁₂, wherein J is Ta, Te, Nb, Sb, W, Mo, Cr, or Ti, (vi) Li₆P₁₋ₘWₘS₅X, wherein X is Br, Cl, or I; and wherein W is Si, Sb, or As, (vii) Li₂QR_{y}, wherein Q is In, Y, Er, Zn, or Zr, and wherein R is Cl, Br, or I, or (viii) Li₃OV, wherein V is Br or Cl, and wherein x, y, and m each have a value of 0 to 1. In some embodiments, the LiCSSE membrane is an Li⁺-selective brine-stable lithium superionic conductor (LiSICON) and comprises one or more layers, optionally comprising one or more alternating porous/dens/porous trilayers in a sandwich structure. In said embodiments, the one or more layers are no more than about 15 microns to about 35 or more microns thick.

In some embodiments, the RFLE system described herein is considered to be as single cell stack, and embodiments are contemplated comprising multiple cell stacks, such as 2, 3, 4, 5, 10, 20, 50, or even 100 cells fluidly connected in serial or parallel, achieving substantial output of Li-rich product. Thus, in certain embodiments, the described RFLE systems further comprise one or more bipolar plates.

In another embodiment, directed to recovery and enrichment of lithium hydroxide, the system comprises an LiCSSE) membrane, an anion exchange membrane (AEM), and three flow cells, wherein the three flow cells comprise an anolyte flow cell, a catholyte flow cell, and a brine water flow cell, wherein the anolyte flow cell and brine water flow cell are fluidly connected to the LiCSSE membrane, wherein the brine water flow cell and the catholyte flow cell are fluidly connected to the AEM. In such embodiments, the anolyte flow cell and catholyte flow cell each comprise an electrode. Further, in such embodiments, the anolyte flow cell comprises an first inlet allowing a flow of lithium-lean base fluid into the anolyte flow cell and an first outlet allowing an outflow of a lithium-rich product from the anolyte flow cell, wherein the lithium-lean base fluid has a lower concentration of lithium as compared with the lithium-rich product. In such systems, the brine water flow cell comprises an second inlet allowing a flow of sea water or brine into the brine water flow cell and an second outlet allowing an outflow of waste water. In such systems, lithium ions are attracted by and pass through the LiCSSE membrane from the brine water flow cell and into the anolyte flow cell, and chloride ions are attracted by and pass through the AEM from the brine water flow cell into the catholyte flow cell. Further, one or more fluid channels continuously circulate fluid comprising a redox shuttle molecule (RSM) through the catholyte flow cell, and the RSM undergoes electrochemical oxidation in the catholyte flow cell while simultaneously the RSM is elsewhere oxidized in a further flow cell to regenerate the reduced RSM. Such systems optionally comprise one or more fluid pumps positioned in line with the one or more fluid channels.

In other embodiments of the described systems, lithium metal, is produced in purified form by the system. Such embodiment comprise an LiCSSE membrane, an anion exchange membrane (AEM), and three flow cells, wherein the three flow cells comprise an anolyte flow cell, a catholyte flow cell, and a brine water flow cell, wherein the anolyte flow cell and brine water flow cell are fluidly connected to the LiCSSE membrane, wherein the brine water flow cell and the catholyte flow cell are fluidly connected to the AEM. In such embodiments, the anolyte flow cell and the catholyte flow cell each comprise an electrode. Here, the anolyte flow cell comprises an first inlet allowing a flow of lithium organic electrolyte fluid into the anolyte flow cell and an first outlet allowing an outflow of a lithium organic electrolyte from the anolyte flow cell. In these embodiments, the electrode in the anolyte flow cell attracts deposits of lithium metal during operation of the system. In this embodiment, the brine water flow cell comprises an second inlet allowing a flow of sea water or brine into the brine water flow cell and an second outlet allowing an outflow of waste water.

In the lithium metal extraction embodiment, lithium ions are attracted by and pass through the LiCSSE membrane from the brine water flow cell and into the anolyte flow cell, and chloride ions are attracted by and pass through the AEM from the brine water flow cell into the catholyte flow cell. As in other embodiments, one or more fluid channels continuously circulate fluid comprising a redox shuttle molecule (RSM) through the catholyte flow cell, and the RSM undergoes electrochemical oxidation in the catholyte flow cell while simultaneously is elsewhere oxidized in a further flow cell to regenerate the reduced RSM. Likewise, such embodiments may optionally comprise one or more fluid pumps positioned in line with the one or more fluid channels.

In such embodiments directed to lithium metal (s) extraction, the anolyte flow cell comprises a lithiophobic anode. The lithium collects onto the lithiophobic anode in particles, as a precipitate thereon, which is later removed from the lithiophobic anode in flakes. In such embodiments directed to lithium hydroxide extraction and lithium metal extraction, the RSM is regenerated either chemically or electrochemically. In chemical regeneration, a reducing agent, such as a saccharide, such as, but not limited to, glucose or sucrose, is employed to assist in RSM regeneration. In electrochemical embodiments, further flow cells comprise a reducing agent such as, but not limited to, FeCl₂.

Also described are methods of extracting lithium from various liquid lithium sources using the described systems, which comprise providing a system as described in, for instance, FIG. 1A, FIG. 1B, or FIG. 1C, pumping lithium base fluid (lithium-lean fluid) into the inlet of the lithium base flow cell, pumping sea water or brine water into the brine water flow cell of the system, circulating fluid from the anolyte flow cell to the catholyte flow cell and vise versa, as in the system of FIG. 1A, and collecting the lithium-rich product from the first outlet and/or the second outlet. In such methods, the lithium-lean base fluid has a lower concentration of lithium as compared with the lithium-rich product fluid.

This Summary is provided to introduce a selection of concepts in a simplified form that are further described below in the Detailed Description. This Summary is not intended to identify critical or essential features of the claimed subject matter, nor is it intended to fully limit the scope of the claimed subject matter described more fully hereinbelow.

### BRIEF DESCRIPTION OF THE DRAWINGS/FIGURES

For a more precise understanding of the disclosed systems, compositions, and methods of use thereof, reference is made to specific embodiments thereof illustrated in the drawings. The drawings presented herein are not drawn to scale and any reference to dimensions in the drawings or the following description are with reference to specific embodiments. It will be clear to one of skill in the art that variations of these dimensions are possible while still maintaining full functionality for the intended purpose. Such variations are specifically contemplated and incorporated into this disclosure notwithstanding the specific embodiments set forth in the following drawings.

FIG. 1A is a schematic of an embodiment of the described redox flow lithium extraction system highlighting its various components for lithium extraction to produce lithium chloride (LiCl).

FIG. 1B is a schematic of a further embodiment of the described redox flow lithium extraction system highlighting its various components for lithium extraction to produce lithium hydroxide (LiOH), and the regeneration of redox shuttle molecules by electrochemical reaction.

FIG. 1C is a schematic of a further embodiment of the described redox flow lithium extraction system highlighting its various components to produce lithium metal (solid), and the regeneration of redox shuttle molecules by electrochemical reaction.

FIG. 1D is a diagram of an exemplary RFLE stack.

FIG. 2 is an electrochemical reaction scheme showing an embodiment of the redox shuttle system electrochemical reactions using FcNCl as the redox active molecule shuttling charge continuously between the catholyte and anolyte flow cells.

FIG. 3 depicts a multi-stack embodiment of the described system.

FIG. 4 is a diagram of an embodiment showing conversion of LiCl into LiOH by passage of LiCl through a membrane electrodialysis stack.

FIG. 5A is a digital image of laminated green tape of an embodiment of the porous/dense/porous trilayer “lithium ion-selective brine-stable lithium superionic conductor” (LiSICON) membrane fabrication.

FIG. 5B is a digital image of sintered LiSICON membranes of an embodiment of the porous/dense/porous trilayer LiSICON membrane fabrication.

FIG. 5C is a digital image of a cross-section SEM of an embodiment of the porous/dense/porous trilayer LiSICON membrane.

FIG. 5D is a digital image of a cross-section SEM of an embodiment of the porous/dense/porous trilayer LiSICON membrane.

FIG. 6A is a digital image of a laser-cut green disc sandwich assembly embodiment of the porous/dense/porous trilayer LiSICON membrane.

FIG. 6B is a digital image of embodiments such as honeycomb, triangular, and square grid geometries of the porous/dense/porous trilayer LiSICON membrane.

FIG. 7A is a photograph of a prototype example of a sandwich-type arrangement of the RFLE flow stack being held by a human gloved hand at 1.6 cm².

FIG. 7B is a photograph showing the lithium base side of an LZSP membrane after 60 hours of continuous RFLE use.

FIG. 7C is a photograph showing the simulated brine side of an LZSP membrane after 60 hours of continuous RFLE use.

FIG. 7D is a graph showing obtained RFLE cell voltage at different tested current densities.

FIG. 7E is a graph showing the obtained RFLE rate versus SEC relationship at tested current densities.

FIG. 8 provides a Nyquist plot of RFLEs described herein showing the relationship between ion, charge, and mass transport resistances (R_{Ω}, R_{CT}, and R_{MT}, respectively).

FIG. 9 depicts a scheme for synthesis of 1,1′-bis[3-(trimethylammonio) propyl]ferrocene dichloride (BTMAP-Fc).

FIG. 10 is a graph showing lithium extraction flow battery (LEFB) performance at different flow rates.

FIG. 11 shows a graph of the charge profiles of an LEFB with 0.05 mol/L FcNCl and 0.15 mol/L NaCl at different current densities ranging from 1 mA/cm² to 10 mA/cm².

FIG. 12 shows a graph of the charge profiles of an LEFB with 0.2 mol/L FcNCl at different current densities ranging from 1 mA/cm² to 20 mA/cm².

FIG. 13 is a graph showing the trade-off between energy consumption and lithium extraction rate of an LEFB operated at 0.05 mol/L FcNCl and 0.15 mol/L NaCl and at different current densities ranging from 1 mA/cm² to 10 mA/cm².

FIG. 14 is a graph showing the trade-off between energy consumption and lithium extraction rate of an LEFB operated at 0.2 mol/L FcNCl and at different current densities ranging from 1 mA/cm² to 20 mA/cm².

FIG. 15 is a graph showing cell voltage over time of an LEFB operated at 0.2 mol/L FcNCl and at 10 mA/cm² and, using a flow rate of 40 mL/min.

### DETAILED DESCRIPTION

### Definitions

The term “a” or “an” entity as used herein refers to one or more of that entity; for example, “a flow cell,” is understood to represent one or more flow cells. As such, the terms “a” (or “an”), “one or more,” and “at least one” are herein used interchangeably herein.

Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “about” or “approximately” refers to a variation of 10% from the indicated values (e.g., 50%, 45%, 40%, etc.), or in case of a range of values, means a 10% variation from both the lower and upper limits of such ranges. For instance, “about 50%” refers to a range of between 45% and 55%.

Unless defined otherwise, scientific terms used herein have the same meaning as commonly understood by one of ordinary skill in the art to which this disclosure is related.

Units, prefixes, and symbols are denoted in their Systeme International de Unites (SI) accepted form. Numeric ranges are inclusive of the numbers defining the range. The headings provided herein are not limitations of the various aspects or aspects of the disclosure, which can be had by reference to the specification as a whole. Accordingly, the terms defined immediately below are more fully defined by reference to the specification in its entirety.

The term “flow cell” as used herein means a container comprising an inlet and an outlet, wherein reactants or substrates for reaction flow fluidly into the container through the inlet and then flow out of the container through the outlet. The container is designed to hold liquid in a liquid-tight manner and allow a flow of fluid from one or more inlets through the container to one or more outlets.

The term “fluid channel” as used herein means a pipe, tube, or other conveyance means for carrying liquid fluidly connected to one or more flow cells. The fluid channel conveys the redox shuttle molecule from one part of the RFLE cell stack to another, and is connected to one or more inlets and outlets of the various flow cells.

The term “catholyte flow cell” as used herein means a flow cell in which electrons are gained by the redox shuttle molecule. In the catholyte flow cell, the redox shuttle molecule loses electrons and becomes oxidized. The catholyte flow cell may comprise one or more electrodes.

The term “anolyte flow cell” as used herein means a flow cell in which electrons are gained by the redox shuttle molecule, which is reduced, as a result. The anolyte flow cell may comprise one or more electrodes.

The term “lithium base flow cell” or “lithium ion flow cell” as used herein means a flow cell in which lithium ion is enriched. In the lithium base flow cell, lean lithium-lean liquid, i.e., liquid being low in lithium ion concentration, enters through one or more inlets, and lithium-rich liquid, i.e., liquid having a lithium ion concentration greater than the lithium-lean liquid, exits from the flow cell through one or more outlets.

The terms “water flow cell” and “brine water flow cell” are used interchangeably herein and means a flow cell into which flows a geothermal brine liquid, or seawater, through one or more inlets of the brine water flow cell. This flow cell is alternatively referred to herein as a brine water flow cell or geothermal brine flow cell, and the like. Into this flow cell flows the liquid raw seawater or Saline from which lithium is to be extracted by the RFLE.

The term “anion exchange membrane” (AEM) as used herein means a flat sheet-like polymeric material comprising ionic exchange groups. Such membranes are commercially available in different sizes and thicknesses and comprise different available polymers. (See, AMVN, DSVN, AAVN, ASVN, and AHO products (these are product names), for example, from SELEMION™, AGC Chemicals Americas, Inc., Exton, PA, US). Such membranes are in the form of a flat sheet with varying thickness and having an amorphous phase for ion transport. The AEM is highly selective for negative ions, such as chloride ions, hydroxide ions, carbon trioxide, and the like.

The term “redox shuttle molecule” (RSM) as used herein means a chemical molecule that carries or is capable of carrying one or more electrons. The RSM acts as a redox component carrying electrons from one flow cell, the catholyte flow cell, to another flow cell, i.e., the anolyte flow cell, such that within the catholyte flow cell, the RSM is oxidized, and within the anolyte flow cell, the RSM is reduced. The RSM aids in removal of ions from one flow cell to another to facilitate enrichment of lithium ion in the RFLE.

The term “lithium ion-selective brine-stable lithium superionic conductor” (LiSICON) as used herein means a material that possesses highly selective (ion-selective) high ionic conductivity over a broad range of temperatures and having the chemical formula Li₂₊₂ₓZn₁₋ₓGeO₄, and the like, but is thermally and electrochemically stable over long periods of time. Such conductors are commercially available in many different formats, shapes, sizes, and ion selectivity. The LiSICON, as implied by its name, is highly selective for lithium ion, meaning that it very efficiently conducts lithium ions. The LiSICON membrane is a type of lithium-ion conducting solid-state electrolyte (LICSSE). That is, LICSSE membranes, i.e., membranes made of LICSSE material, are a broader category of such membranes possessing the aforementioned functionality, while LiSICON membranes, i.e., membranes made of LiSICON materials, are a species of LICSSE membranes especially designed for this task and possessing additional stability in saltwater environments. LiSICON materials are synthesized as powders, tape-cast into thing films and then sintered into membranes. These membranes will be of varying thicknesses such that they provide greater than 1 mS/cm conductivity. An optimal thickness of the described membranes allows for a balanced tradeoff between low area specific resistance (ASR) and mechanical strength.

The RFLE technology described herein achieves energy-saving, fast-rate, high-purity lithium obtention and has many advantages over legacy technologies aimed at lithium production. Because of its cell design, the RFLE systems and methods described herein aid in addressing the technical issues facing the lithium field. Due to the high Li⁺ and counter ion selectivities enabled by the membranes employed in these described systems, a continuous mode of high-purity lithium collection directly from the geothermal brine is obtained. The symmetric redox shuttling operation achieved by RSMs gives rise to a near-zero cell voltage. Therefore, a dramatic drop in energy consumption is observed. The flow cell designs described herein allow for a theoretically infinite lithium extraction capacity ascribed to the uninterrupted redox shuttling reactions, and high lithium extraction rates enabled by the fast kinetics of solution-phase reactions.

Taking advantage of recent progress in flow batteries, counter ion-bearing organic redox molecules that have high chemical stability and crossover resistance are employed at only mM-scale concentrations, yielding operational longevity and low cost benefits. Importantly, the RFLE systems and methods described herein are highly and directly adaptable to diverse lithium sources with both ultra-dilute (seawater) to concentrated (Salar brines) lithium. Finally, the RFLE systems and methods described herein use electrons to drive pure lithium harvesting and thus eliminates the needs for chemical addition, pretreatment and purification procedures. Its operation does not require use of large volumes of land and water and generates only a negligible amount of wastes. With the other ions remaining, the delithiated geothermal brine can be pumped directly back to recharge the geothermal reservoirs. These features lead to an important advantage of environmental benignity.

Thus, the RFLE systems and methods described herein advances the state of the art of the lithium extraction field. Compared to the current commercial and near-mature lithium mining technologies, the RFLE systems and methods described herein offers the following advantageous performance characteristics: (i) low energy consumption, (ii) fast extraction rate, (iii) high product purity, (iv) unlimited extraction capacity, (v) continuous, uninterrupted extraction, (vi) environmental friendliness, and (vii) ready adaptability to diverse brine sources. It should be noted that the RFLE systems and methods described herein are in some embodiments able to be used for primary resource as well as secondary resource processing. The various elements, aspects, uses, features, and performance metrics of the RFLE systems are described hereinbelow.

### RFLE Systems and Methods

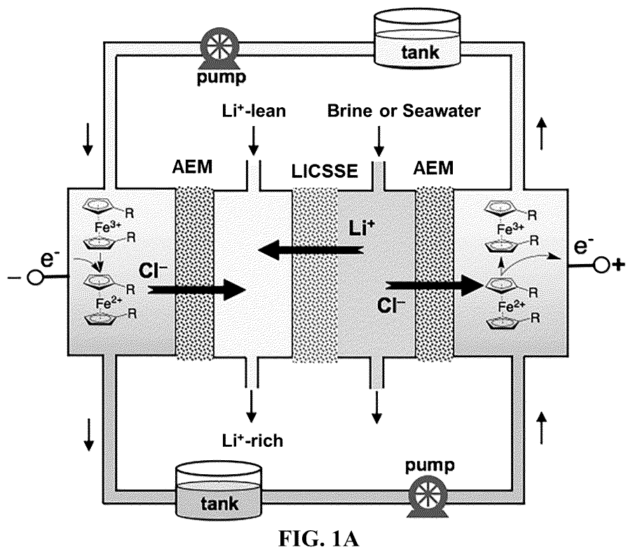

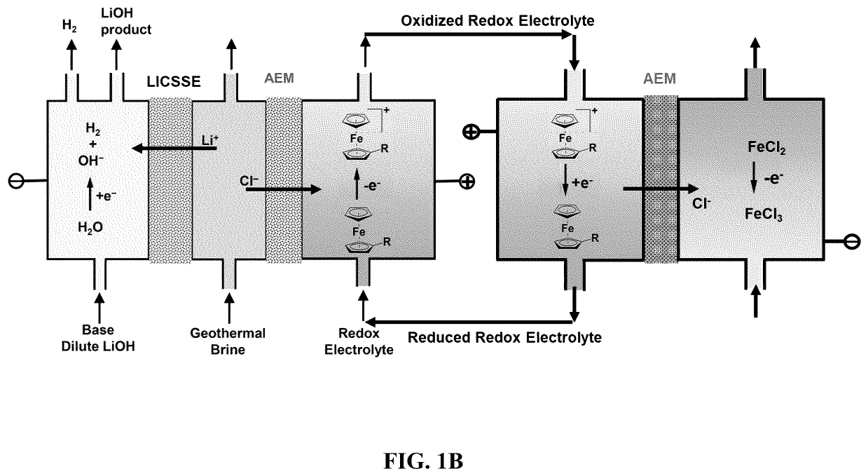

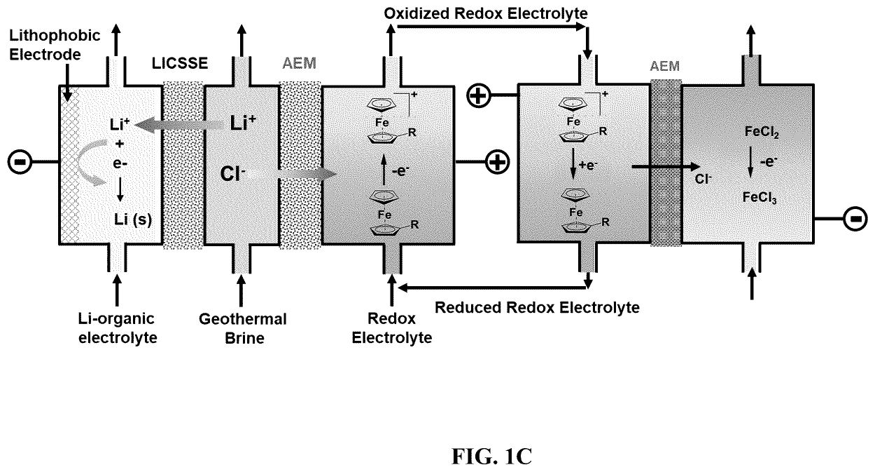

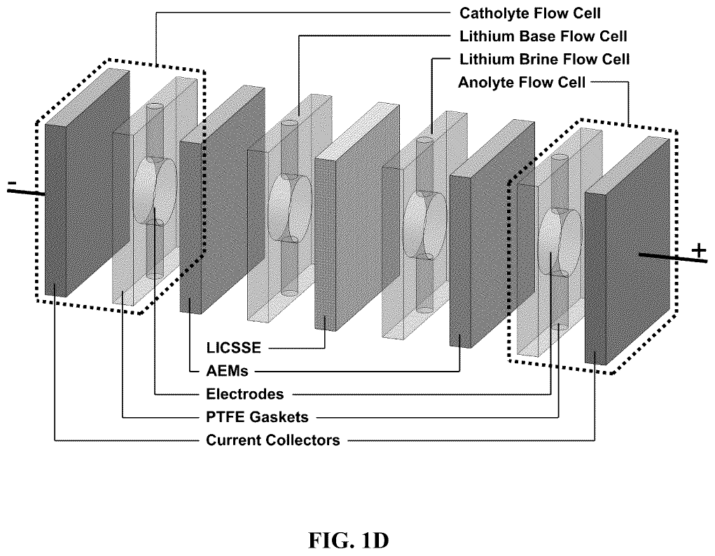

FIGS. 1A, 1B, and 1C provide depictions or schematic diagrams of at least three different embodiments of the RFLE systems described herein, each aimed at enriching the lithium ion concentration in a liquid flow stream or depositing lithium metal (solid). FIG. 1A provides an exemplary RFLE system designed to, for instance, enrich lithium to produce LiCl. FIG. 1B provides an exemplary RFLE system designed to, for instance, enrich lithium to produce LiOH. FIG. 1C provides an exemplary RFLE system designed to, for instance, enrich lithium to produce lithium metal (solid). It should be understood that any of these ions may be produced from a raw material source, i.e., seawater or geothermal brine, using various interchangeable components of these systems with the properly selected AEM and RSM.

As shown in FIG. 1A, embodiments of the RFLE cell systems described herein include in one version at least four flow cells. Two of the flow cells in this embodiment are separated by an LICSSE membrane, which in some embodiments is an LiSICON membrane. Placed on either side of these two flow cells are anion exchange membranes (AEMs) followed by a catholyte or an anolyte flow cell on either side. Thus, the four flow cells are arranged serially as depicted in the embodiment of FIG. 1A. Here, the geothermal brine and the lithium product streams are fed in parallel into the middle two flow cells and are separated by the LICSSE membrane. However, it is understood that these are not the only two types of sources of lithium ion amenable to extraction using the described system.

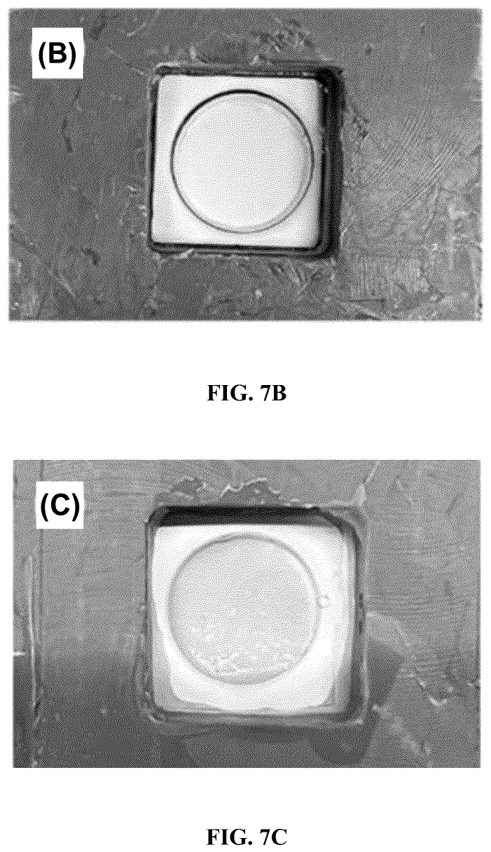

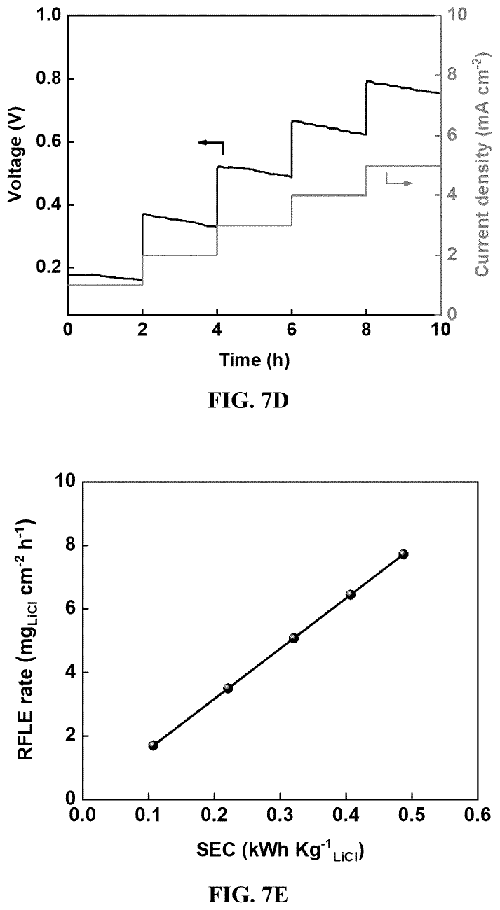

FIG. 7A provides a photograph of a small-scale prototype example of the RFLE systems described herein, being held by a gloved hand. This photograph shows the anolyte and catholyte flow cells, lithium base flow cell and brine or seawater flow cell, along with associated inlets and outlets attached thereto, creating an example of the sandwich-type geometry embodiment. Between the various layers appearing in thin, white, square layers are the membranes, of which you can see three in this picture.

In the system of FIG. 1A, raw material, i.e., seawater, is pumped or flows into the brine water flow cell through one or more inlets. This flow cell has on one side an LICSSE membrane and on its opposite side, an AEM, in place of those two walls of the flow cell. These two membranes allow lithium ions, on the LICSSE membrane side, to flow from the brine water flow cell into the neighboring or adjacent flow cell, i.e., the lithium ion flow cell. On another side of the brine water flow cell sits the AEM. The AEM is designed or selected such it is highly selective for conducting the lithium counter ion (hydroxide, chloride, carbon trioxide, etc.). Arranged in such a manner, the lithium counter ion is stripped from lithium and conducted out of the brine water flow cell and into an adjacent anolyte flow cell. Exiting through an outlet of the brine water flow cell is the waste seawater from which the lithium ion and counter ions have been extracted. It is to be understood that the seawater enters the brine water flow cell through one or more inlets via a flow channel. The flow channel may simply be placed into a seawater holding pond, tank, or other location holding raw seawater. In some embodiments, the raw seawater is first filtered to remove large particulates before entering the RFLE system.

In FIG. 1A, the catholyte and anolyte flow cells are situated on opposite ends of the RFLE stack and are interconnected by flow channels as depicted. The product produced when such a system is in operation is the “Li⁺-rich” flow stream that exits through an outlet of the lithium base flow cell. Further manipulations may be carried out on this product flow stream to further enrich the lithium contained therein, such as additional or multiple passages through the RFLE systems described herein, but also including other legacy methodologies that may be used to further enrich the lithium within this stream, as needed or desired. In another embodiment of the described systems, as shown in FIG. 1B, only three flow cells are utilized. Here, the three flow cells include: a catholyte flow cell, an anolyte flow cell, and a geothermal brine (water) flow cell. The anolyte flow cell depicted on the left side of FIG. 1B and the geothermal brine flow cell are fluidly connected by an LICSSE membrane, and the geothermal brine flow cell is fluidly connected to a catholyte flow cell by an AEM.

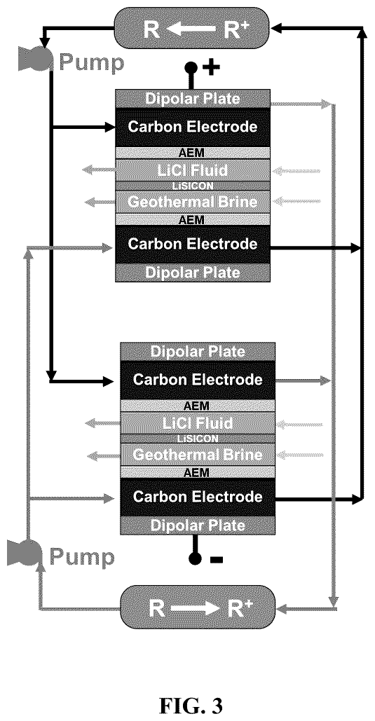

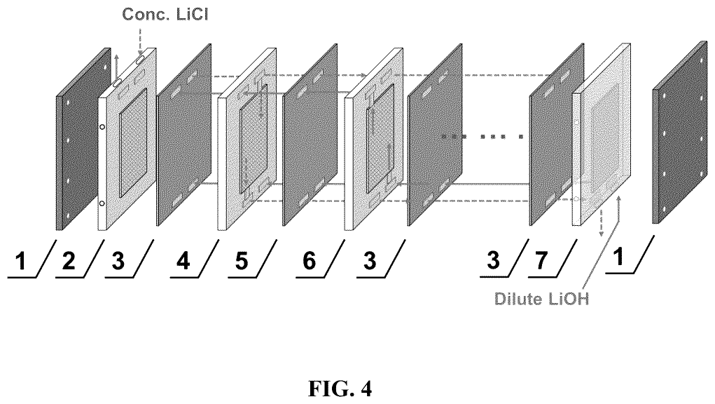

In addition, in some embodiments, the produced LiCl is converted into LiOH by membrane electrodialysis. (See, FIG. 4). The current density for electrodialysis is in the range of from about 1 mA/cm² to 200 about mA/cm². The flow rates of concentrated LiCl solution and dilute LiOH solution are in a range from about 30 mL/min to about 500 mL/min. Cation exchange membranes (CEMs) used in this embodiment are not particularly limited and are commercially available products, such as Nafion 115 and Nafion 117 available from manufacturers such as Ion Power (Tyrone, PA, US). The anion exchange membranes (AEMs) would be those commercially available from companies such as AGC Engineering (Chiba City, Chiba, JP).

As an example of further downstream processing of the product stream created by the RFLE described herein, in some embodiments, the lithium-rich product stream is further concentrated to about 3000 ppm to about 5000 ppm lithium. In such embodiments, the lithium enriched solution is collected from lithium base flow cells and further manipulated by known means to concentrate the product to the desired ppm. Additionally, captured LiCl, in some embodiments, is converted into Li₂CO₃ by known means, such as by adding soda ash (Na₂CO₃), at a temperature ranging from about 25° C. to about 100° C. In such embodiments, high-purity crystalized Li₂CO₃ is recovered.

In other embodiments, compressed CO₂ is added to convert LiCl into Li₂CO₃ owing to circular economy and environmental sustainability. The compressed CO₂ may be supplied through a plastic hose or other gas channel into concentrated LiCl product stream at the temperature ranging from about 25° C. to about 100° C. The flow rate of CO₂ is adjusted in the range of about 1 to about 10 bubbles per second, for instance, using a downstream bubble counter. In such embodiments, high-purity crystalized Li₂CO₃ is recovered.

FIG. 4 shows a stacked lithium salt conversion system for converting LiCl to LiOH, where one can quickly visualize the LiOH base flow input channel and the concentrated LiCl flow input channel. In FIG. 4, plate 1 is the end plate, plate 2 is the anode plate, plate 3 is the CEM, plate 4 is the lithium flow cell, plate 5 is the AEM, plate 6 is the dilute LiOH base flow cell, and plate 7 is the cathode plate. As depicted in these diagrams of a stacked RFLE, the inner central part of each flow cell plate is an open area represented by hash marks which is surrounded by solid walls/barriers to prevent leakage or escape of liquid. Liquid is then free to flow from the inlet to the outlet within the flow cell plates, as well as allowing physical contact of the liquid with the membrane plates 3 and 5, for example. Notches shown in the tops and bottoms of the plates are where fluid channels allow flow of the RSMs from one flow cell to another, and back, etc.

End plates 1 are able to be affixed to one another thereby creating a sandwich. The end plates are in some embodiments made of metals or composite metals, such as stainless steel, aluminum, titanium. In other embodiments the end plates are comprised of one or more polymer materials, such as polyvinyl chloride (PVC), polypropylene (PP), and/or poly ethyl ether ketone (PEEK). Affixing endplates together is achieved by screws or clamps. When the end plates are comprised of metal materials, such embodiments optionally include within the assembly one or more insulating gaskets, made of rubber materials and/or poly tetra fluor ethylene (PTFE), and in some embodiments insulating washers are included to inhibit short circuits.

In the described RFLE system of FIG. 1B, raw seawater is pushed through one or more inlets of the brine water flow cell. In the brine water flow cell, by action of the LiCSSE membrane, lithium ions are conducted across the LiCSSE membrane and into the neighboring anolyte flow cell on the lefthand side of the figure. Simultaneously, counter ions, such as chloride ion, is conducted through the AEM and into the neighboring catholyte flow cell. Waste eluate is then directed out of the brine water flow cell through one or more outlets of the brine water flow cell. An output of raw seawater waste water is then expelled from the brine water flow cell through one or more outlets connected to the brine water flow cell. Thus, in the embodiment depicted in FIG. 1B, as many as five different flow cells are included in the system.

In the anolyte flow cell of FIG. 1B, a dilute LiOH base solution is provided which flows into an inlet of the anolyte flow cell. This solution has an LiOH concentration of between about 0.05 M to 0.20 M. Within the anolyte flow cell, the water molecules are electrolyzed into hydrogen (H₂) and hydroxide groups (OH⁻) using a catalyst, such as, but not limited to, platinum, and the like. Hydrogen gas may be captured from the system for proton exchange membrane fuel cell (PEMFC), ammonia production, methanol and synthetic fuels applications, petroleum refining, welding, annealing, and heat-treating metals, and the like. The hydroxide ions are coupled with Li⁺ ion to form LiOH. These products then leave the anolyte flow cell through one or more outlets fluidly connected to flow channels that then may be collected.

In the catholyte flow cell, the redox shuttle molecules are electrochemically oxidized. In one embodiment, the oxidized electrolyte is chemically reduced to an initial state of charge by added reducing agents, such as glucose, fructose, or other saccharide, for example. Glucose, fructose or other saccharide are inexpensive reducing agents that are readily available, and produce non-contaminating products of only CO₂ and H₂O. In another embodiment, the oxidized electrolyte (RSM) is reduced to an initial state of charge by electrochemical reaction, as depicted in FIG. 1B and FIG. 1C. In this embodiment, the oxidized FeCl₃ electrolyte is converted to FeCl₂ by adding Fe(s), which is recycled for catholyte regeneration.

Thus, in the embodiment depicted in FIG. 1B, oxidized RSM flows out of the catholyte flow cell, through one or more outlets to a further flow cell, and returns through an outlet of that further flow cell back to the catholyte flow cell. Here, chloride ion migrates through the AEM to yet a further flow cell, as depicted in FIG. 1B. That is, the further flow cell is fluidly connected to an AEM. On the opposite site of the AEM is yet a further flow cell where chloride ion reacts with FeCl₂ to yield FeCl₃.

It is to be understood that various other RSMs are substitutable within these schematics depicted in FIG. 1A, FIG. 1B, and FIG. 1C, as described further hereinbelow. The oxidized RSM then leaves the catholyte flow cell through one or more outlets to a flow channel that is then, in some embodiments, for example, fluidly connected to one or more pumps, holding tanks, and the like, and may also be then recycled back into a fluid channel connected to the one or more inlets of the catholyte flow cell.

FIG. 1C provides a schematic depicting yet another embodiment of the described RFLE systems. In this embodiment, lithium ion is converted to lithium (solid) via collection on a lithiophobic anode for lithium deposition on one wall of the anolyte flow cell depicted therein. That is, the lithium metal is collected as a solid as it is deposited onto the lithiophobic anode in the anolyte flow cell. The deposited lithium metal precipitates as particles onto the lithiophobic anode, and then can be removed from lithiophobic anode in the form of flakes or precipitated deposits, in one embodiment.

The collected lithium metal products, collected in the forms of lithium metal flakes or particles, are washed using blank organic solvents and then dried under vacuum (about 10 psi to about 30 psi) at a temperature of from about 20° C. to about 100° C. In this embodiment, the blank organic solvents include, but are not limited to, diethyl carbonate (DEC), dimethyl carbonate (DMC), ethyl methyl carbonate (EMC), 1,3-dioxolane (DOL), and dimethoxy ethane (DME), for example.

In this embodiment raw geothermal brine is pushed via pump or other means into one or more inlets of the brine water flow cell in the middle of the diagram. In the brine water flow cell, as in other embodiments, lithium ion is separated from negative counter ion and each ion is conducted out of the brine water flow cell through one or more membranes, such as the LiCSSE and AEM membranes. The redox flow lithium extraction system for lithium metal products depicted in FIG. 1C comprises one or more LiCSSE membranes, AEMs, and as many as five flow cells including a catholyte flow cell, an organic anolyte flow cell, and a geothermal brine (water) flow cell, as well as two further flow cells serving the purpose of RSM recycling, as in FIG. 1B. The system of FIG. 1C further comprises at least one lithiophobic anode. The organic anolyte flow cell and the geothermal brine flow cell in this embodiment are separated by a LiCSSE membrane. The geothermal brine flow cell and catholyte flow cell are separated by an AEM.

In the described anolyte flow cell of FIG. 1C, a lithiophobic anode is included in the system for lithium metal collection. The lithiophobic anode is, in one embodiment, bare copper foil. In another embodiment the lithiophobic anode is comprised of Cu/ceramic composite material, and the like. In such composite electrodes, the ceramics are lithiophobic materials, including, but not limited to, garnet-type lithiophobic ceramic materials, such as Li₇La₃Zr₂O₁₂ (LLZO) and Li₇La₃Zr_{1.4}Ta_{0.6}O₁₂ (LLZTO). On the surface of the lithiophobic electrode, the lithium metal is deposited. After the system has operated for a time, the deposited lithium is detached during an organic electrolyte circulation phase of system operation.

In the described RFLE system of FIG. 1C, the lithium ions are recovered from the geothermal brine through the LiCSSE membrane into lithium organic electrolyte, and chloride ions are conducted through the AEM into the catholyte flow cell. The lithium ions in the lithium organic electrolyte are plated onto the lithiophobic anode in the anolyte flow cell, and the lithium metal is subsequently detached from the lithiophobic anode during electrolyte circulation. A base organic solution of dilute lithium salts (about 0.01 M to about 0.1 M) is pushed into an inlet of the anolyte flow cell to provide necessary ionic conductivity for the anolyte flow cell operation. The lithium salts include one or more but not limit LiPF₆, LiClO₄, LiBF₄, LiAsF₆, LiF₂S₂NO₄ (LiFSI) and (CF₃SO₂)₂NLi (LiTFSI). The solvents in the anolyte flow cell include one or more but not limit ethylene carbonate (EC), diethyl carbonate (DEC), dimethyl carbonate (DMC), ethyl methyl carbonate (EMC), fluoro ethylene carbonate (FEC), 1,3-dioxolane (DOL), dimethoxyethane (DME), diglyme (G2), and triglyme (G3).

In the catholyte flow cell of FIG. 1C, the RSMs are electrochemically oxidized. To achieve continuous RFLE operation, the catholyte can be chemically regenerated by adding reducing agent such as, in one embodiment, glucose, fructose, or other saccharide. Glucose or fructose are good candidates for reducing agents in this context since their reactions produce non-contaminating products of only CO₂ and H₂O. In another embodiment, the oxidized electrolyte (RSM) is reduced to an initial state of charge by electrochemical reaction, as depicted in FIG. 1B and FIG. 1C. In this embodiment, the oxidized FeCl₃ electrolyte is converted to FeCl₂ by adding Fe(s), which is recycled for catholyte regeneration.

It is noteworthy that contemplated herein are embodiments of systems that are applicable not only to production, enrichment, or purification of LiCl, but also are capable of producing other lithium-counter ion pairs, such as, but not limited to, LiOH (LiOH·H₂O), Li₂CO₃, and lithium metal. In some embodiments, the system produces an LiOH (LiOH·H₂O) stream alone and no LiCl by conversion of LiCl into LiOH using, for instance, the membrane electrodialysis system depicted in FIG. 4. In some embodiments the systems produce a combination of both of LiOH (LiOH·H₂O) and LiCl. In some embodiments the Li₂CO₃ is produced by adding soda ash (Na₂CO₃) or CO₂ to the extracted LiCl solutions. The foregoing description centers on the lithium species extraction, but it is to be understood that substitutable for these systems and methods are those that produce LiOH (LiOH·H₂O), Li₂CO₃, and lithium metal.

It is to be generally understood that the embodiments of FIG. 1A, FIG. 1B, and FIG. 1C also are contemplated as optionally including additional holding tanks, pumps, and fluidly connected flow channels as needed to maintain circulation of RSMs, removal of waste water, and enrichment of lithium in the desired product streams. For instance, in the system depicted in FIG. 1A, shown are two optional pumps in line with the redox shuttle flow channels. In practice, one or more pumps may be employed to maintain proper flow of the redox shuttle molecules from one flow channel to another to maintain continuous extraction within the RFLE. One or more pumps are, in some embodiments, also employed to maintain flow of raw materials into the Li base and brine flow cells. These flow cells typically comprise both inlets and outlets. The concentrated Li⁺-rich product is then collected in one or more holding vats or containers exiting the outlets of these flow cells. Such tanks and pumps are also employed in some embodiments in the RFLE systems diagramed in FIG. 1B and FIG. 1C as well. Optionally, the system also comprises in some embodiments one or more holding tanks distributed where needed within the system, for instance as depicted in FIG. 1A. These holding tanks are useful to maintain fluid volume and to replenish redox shuttle molecule as needed over time. Such holding tanks are in some instances plumbed in line with the system through various flow channels.

In some embodiments, the RFLE system is composed of sandwiched flow cells, creating a stack, such as that depicted in FIG. 3. In some embodiments, the RFLE system is composed of multiple stacks, for instance as depicted in FIG. 3, which depicts a double stack (two) of the RFLE systems to be operated in parallel. Such stacked arrangements are manufactured in some embodiments through use of laser etching techniques and other known fabrication technologies as described hereinbelow. In some embodiments, the system comprises two stacks, three stacks, four stacks, five stacks, ten stacks, twenty stacks, or as many as up to 100 stacks in a single system. Such systems are contemplated as running in series or in parallel to achieve the greatest volume output of pure lithium and greatest purity of lithium desired.

For instance, in FIG. 3, an embodiment is depicted in which two RFLE stacks are aligned in parallel to achieve twice the output of a single RFLE cell stack. Here, all elements of FIG. 1A are repeated twice and sufficient fluid channels are established allowing efficient and controlled flow of substrates and products through the double stack system depicted in FIG. 3.

### The Redox Shuttle Molecule (RSM)

Redox shuttle molecules are employed by the various embodiments of the RFLE systems described herein to continuously replenish needed electrons in the system that maintain the proper electrochemical balances across the various AEM and LiSICON membranes. In the embodiment depicted in FIG. 1A, a redox couple (RSM) is shuttled between through the flow channels from one flow cell to another, such that the RSM continuously undergoes oxidation in the catholyte flow cell and reduction in the anolyte flow cell. In the embodiments depicted in FIG. 1B and FIG. 1C, the RSM is continuously circulated through only the catholyte flow cell, where the oxidized RSM undergoes reduction by chemical or electrochemical reaction. In one embodiment, the oxidized RSM is chemically reduced by continuously adding reducing agents, such as glucose, fructose, or other saccharide, for example. In another embodiment, the oxidized RSM is reduced to an initial state of charge by electrochemical reaction, as depicted in FIG. 1B and FIG. 1C. In this embodiment, the oxidized FeCl₃ electrolyte is converted to FeCl₂ by adding Fe(s), which is recycled for catholyte regeneration.

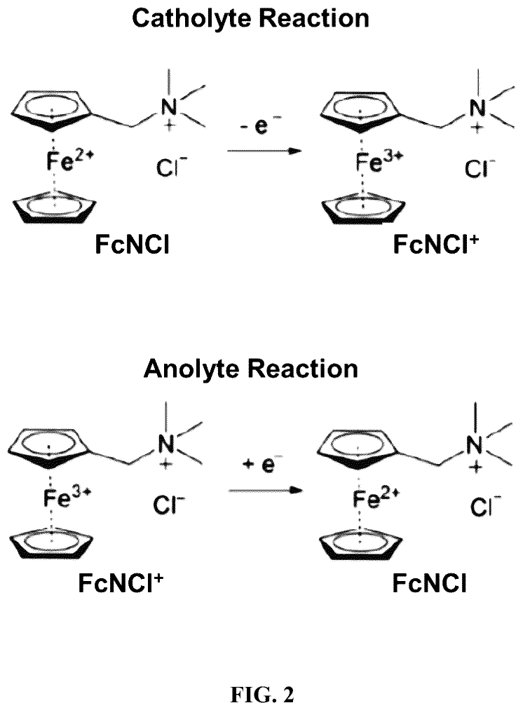

An exemplary embodiment of this chemical reaction scheme is depicted in FIG. 2, showing both the catholyte reaction (top) and the anolyte reaction (bottom) chemistry of, for instance, the (ferrocenylmethyl) trimethylammonium chloride (FcNCl) molecule. That is, a non-limiting, exemplary organometallic redox shuttle (RSM) compound with established chemical stability, i.e., (ferrocenylmethyl) trimethylammonium chloride (FcNCl), and its electrochemical reactions in catholyte and anolyte are indicated in FIG. 1, showing electron donation and electron withdrawal cycles. The charge imbalance generated from the redox reactions drives migration of Li⁺ and Cl⁻ ions from the geothermal brine to the LiCl extraction channels. The LiCl channel starts with a dilute LiCl base influent to provide initial ionic conductivity. The redox electrolyte contains a mixture of FcNCl and FcNCl⁺ at a specified state of charge (SOC); typically, about 50% SOC yields the lowest cell overpotential and energy loss.

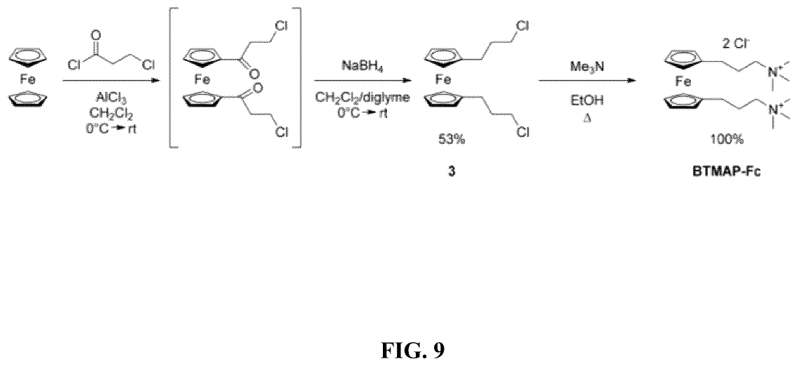

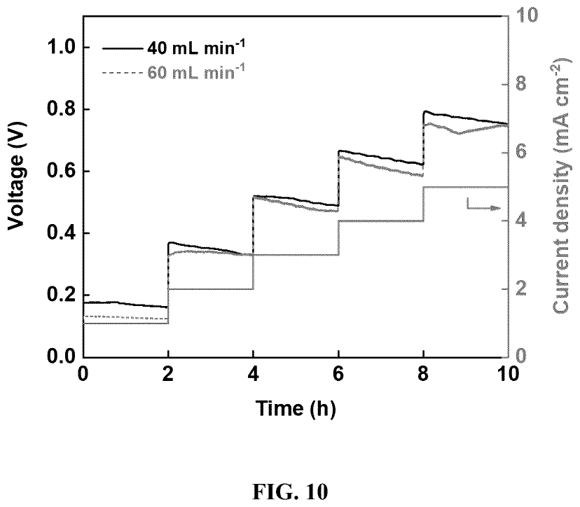

Furthermore, while FcNCl is depicted as the redox flow shuttle molecule in FIG. 1A, other such molecules are known in the art and serve the same purpose equally as well, such as 1,1′-bis[3-(trimethylammonio)propyl]ferrocene dichloride (BTMAP-Fc, FIG. 9). (See, Beh et al., ACS Energy Lett., 2(3):639-644, 2017). Redox kinetics are easily determined for these molecules using Randles-Sevcik analysis correlated with the charge transfer resistance (R_{CT}) of the RFLE cell. In certain embodiments, the SOC is about 50%, about 48%, about 46%, about 40%, about 35% or about 30%, or about 55% or more. In some embodiments the SOC is 51%, 52%, 53%, 49%, 48%, 47%, or 45%. In other embodiments the SOC rises to as high as 90%, 85%, 80%, 75%, 70%, 65%, or 60% or more. In a particular embodiment, the SOC achieved is equal to or greater than 90%. In a further specific embodiment, the SOC is about 20% or about 10%.

Aside from ferrocene-based redox shuttle molecules, other shuttle molecules are employed in embodiments directed to LiCl, LiOH, Li₂CO₃, and lithium metal extraction as depicted in FIG. 1A, FIG. 1B, and FIG. 1C. Such shuttle molecules include, but are not limited to cobaltocene-based materials, TEMPO-based materials (such as 4-hydroxy-TEMPO), phenothiazine-based materials (such as methylene blue), phenazine-based materials (such as 7,8-dihydroxyphenazine-2-sulfonic acid), and metal-ligand complexes, such as, but not limited to, [Ru(bpy)₃]²⁺, [Ni(bpy)₃]²⁺, [Co(bpy)₃]²⁺, and [Fe(bpy)₃]²⁺. Such redox molecules can be employed as redox shuttle molecules in the lithium extraction flow batteries described herein.

The concentration of the redox shuttle molecule in the circulating fluid is not particularly limited but in some embodiments is between about 0.05 M to about 2 M depending on the identity of the RS molecule. In some embodiments, the concentration of the redox shuttle is between 0.05 M and 0.10 M, between 0.05 M and 0.25 M, between 0.05 M and 0.50 M, between 0.05 M and 0.75 M, between 0.05 M and 1.0 M, or between 0.05 M and 1.5 M. In some embodiments, the concentration of the redox shuttle is between 1 M and 2 M, between 0.5 M and 2.0 M, between 0.75 M and 1.0 M, between 0.25 M and 0.5 M, between 0.5 M and 0.75 M, between 1.5 M and 2.0 M, between 1.8 M and 2.0 M, or between 0.1 M and 0.2 M.

### LiCSSE and LiSICON Membranes

In the embodiments depicted in FIG. 1A, FIG. 1B, and FIG. 1C, there exists one or more LiCSSE membranes between the Li⁺ lean flow cell and the brine/seawater flow cell. There may be multiple layers of LiCSSE membranes, or multiple LiCSSE membranes within the flow cell spread apart from each other to allow maximum transport. The one or more LiCSSE membranes in some embodiments are identical and in others are different from one another. This LiCSSE membrane is in some embodiments and LiSICON membrane, and in some embodiments is comprised of one or more of LiSICON-type materials, such as Li_{1.3}Al_{0.3}Ti_{1.7}(PO₄)₃ (LATP), Li_{1+y}Zr₂(SiO₄)_{y}(PO₄)_{3-y} (LYTP), Li₃Zr_{2-y}Si_{2-4y}P_{1+4y}O₁₂ (LZSP), Li₁₊ₓYₓZr₁₋ₓ(PO₄)₃ (LYZP), Li_{1+x+y}Y_{X}Zr₂₋ₓ(SiO₄)_{y}(PO4)_{3-y} (LYZSP), (Li₁₊ₓAl_{y}Ge_{2-y}(PO₄)₃ (LAGP), Li_{1.5}Al_{0.5}Ge_{1.5}(PO₄)₃, and Li_{3.1}Zr_{1.95}Mg_{0.05}Si₂PO₁₂.

The LiCSSE membranes are fabricated using different types of LiCSSE materials, including perovskite oxide LiCSSE material (Li₃ₓLa_{2/3-x}TiO₃, where the La can be submitted by Na, K, Ca, Sr or Ba, and the Ti can be replaced by Sc, In, Al, Sm, Ga, Ti, Zr, Hf, Sn, Ge, Nb or Ta), or garnet-type LiCSSE material (Li₇₋ₓMₓLa₃Zr₂O₁₂, M=Al, Ga, Fe and Ge; Li₇La₃₋ₓNₓZr₂O₁₂, N═Sr and Y; Li₇La₃Zr₂₋ₓBₓO₁₂, B═Ta, Te, Nb, Sb, W, Mo, Cr and Ti), or sulfide LiCSSE material (Li₆P₁₋ₘYₘS₅X, X═Br, Cl and I; and Y═Si, Sb and As), or halide LiCSSE material (Li₂MX_{y}, M=In, Y, Er, Zn and Zr, X═Cl, Br and I), or anti-perovskite oxide LiCSSE material (Li₃OX, X═Br and Cl).

Polymer/inorganic composite LiCSSE membranes, in some embodiments, are made from cation conducting polymers which include but are not limit the following materials: sulfonated poly ether ether ketone, sulfonated poly styrene, sulfonated poly(p-phenylene oxide), and inorganic LiCSSE materials. Inorganic LiCSSE materials include, but are not limited to, perovskite-type oxide LiCSSE material (Li₃ₓLa_{2/3-x}TiO₃, where the La can be submitted by Na, K, Ca, Sr or Ba, and the Ti can be replaced by Sc, In, Al, Sm, Ga, Ti, Zr, Hf, Sn, Ge, Nb or Ta), garnet-type LiCSSE material (Li₇₋ₓMₓLa₃Zr₂O₁₂, M=Al, Ga, Fe and Ge; Li₇La₃₋ₓNₓZr₂O₁₂, N═Sr and Y; Li₇La₃Zr₂₋ₓBₓO₁₂, B═Ta, Te, Nb, Sb, W, Mo, Cr and Ti), sulfide LiCSSE material (Li₆P₁₋ₘYₘS₅X, X═Br, Cl and I; and Y═Si, Sb and As), halide LiCSSE material (Li₂MX_{y}, M=In, Y, Er, Zn and Zr, X═Cl, Br and I), and anti-perovskite oxide LiCSSE material (Li₃OX, X═Br and Cl).

In addition, in some certain embodiments, different inorganic composite LiCSSE membranes are employed as a membrane in the described RFLE system. The inorganic composite LiCSSE membrane may comprise two or more, such as three or more, four or more, or even five to ten or more, of LiCSSE-type perovskite oxide LiCSSE membranes (Li₃ₓLa_{2/3-x}TiO₃, where the La can be submitted by Na, K, Ca, Sr or Ba, and the Ti can be replaced by Sc, In, Al, Sm, Ga, Ti, Zr, Hf, Sn, Ge, Nb or Ta), garnet-type LiCSSE membranes (Li₇₋ₓMₓLa₃Zr₂O₁₂, M=Al, Ga, Fe and Ge; Li₇La₃₋ₓNₓZr₂O₁₂, N═Sr and Y; Li₇La₃Zr₂₋ₓBₓO₁₂, B═Ta, Te, Nb, Sb, W, Mo, Cr and Ti), sulfide LiCSSE membranes (Li₆P₁₋ₘYₘS₅X, X═Br, Cl and I; and Y═Si, Sb and As), halide LiCSSE membranes (Li₂MX_{y}, M=In, Y, Er, Zn and Zr, X═Cl, Br and I), and anti-perovskite oxide LiCSSE membranes (Li₃OX, X═Br and Cl).

In some embodiments, the LiCSSE membrane comprises LATP. For manufacturing, various LiCSSE materials are synthesized as powders, tape-cast into thing films and then sintered into membranes. These membranes will be of varying thicknesses such that they provide greater than 1 mS/cm conductivity. An optimal thickness of the described membranes allows for a balanced tradeoff between low ASR and mechanical strength.

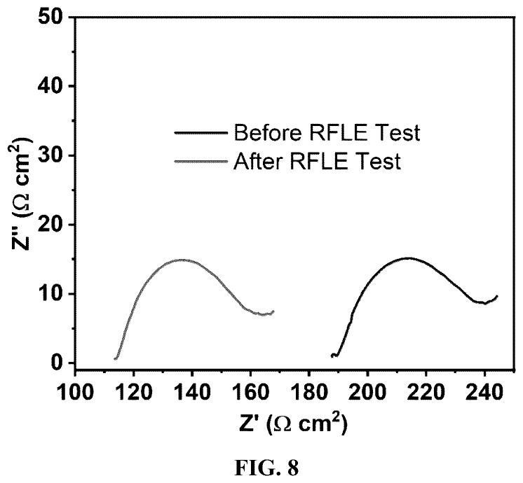

The ASR of an RFLE cell, measured via electrochemical impedance spectroscopy (EIS), reflects its ion, charge, and mass transport resistances (R_{Ω}, R_{CT}, and R_{MT}, respectively) and determines its overpotential and energy loss. Without wishing to be bound by theory, due to the low ionic conductivity, LiCSSE membranes are likely the major ohmic contributors in RFLE cells. This suggestion is supported by the Nyquist plots shown in FIG. 8.

In various embodiments of the LiCSSE membranes incorporated into the systems described herein, the membranes are structurally stable for numerous days, for instance up to about 30, about 60, about 90, about 120, about 240, about 365 days or more, such as about 1, about 2, about 3, about 5, and even about 10 years or more while immersed in or otherwise continually being exposed to geothermal brine conditions.

The LiCSSE material is as much as about 90%, about 92%, about 94%, about 96%, about 98%, and even about 99% or more selective towards lithium ion conduction.

In some embodiments, the LiCSSE membrane is a phase-pure, dense LiCSSE separator membrane that is self-supported. In such embodiments, the LiCSSE membrane has a density of greater than 80%, 90%, 92%, 94%, 96% or even 98% and an ionic conductivity of greater than 1 mS/cm.

LiSICON membranes are generally manufactured using slurry, tape-casting, and sintering techniques to obtain dense membranes with greater than 95% density and greater than 1 mS/cm conductivity. (See, for instance, DeWees et al., ChemSusChem, 12(16):3713-3725, 2019, said methods described therein incorporated herein by reference for all purposes). In some embodiments the LiSICON membrane is self-supported. In some embodiments, the LiSICON membrane is protected by a thin film coating to prevent degradation due to continuous exposure to brine fluids.

LiSICON membranes have been synthesized from various methods known in the art, which are generally described as solid- and liquid-based approaches as generally described below.

The solid-based synthesis methods include solid-state synthesis, melt-quenching, and fast sintering techniques. In solid-state synthesis, the precursors (generally metal oxides) are mixed using ball milling, and complete solid-state reaction and densification through calcination and sintering heat treatment under the conditions of high temperatures (about 700° C. to about 1200° C.) and long dwell times, i.e., more than 12 hours. However, high temperature heat treatment results in lithium source loss and formation of a secondary phase, leading to low ionic conductivity.

In melt-quenching synthesis, the precursors are melted at higher temperatures, i.e., about 1500° C., followed by quenching at room temperature to form an amorphous glass, which is then further sintered to achieve crystallization. The properties of the formed solid electrolyte, including density, ionic conductivity, and phase purity, strongly depend on the chemical precursors, sintering methods, and temperature.

Fast-sintering techniques have been developed to reduce lithium source loss during heat-treatment at high temperatures. In principle, the high heating rates, e.g., more than 100° C. per min, are achieved by utilizing electrical currents, voltage, or electromagnetic energy methods, during solid-state sintering or densification. The high-grade solid electrolytes with high density, ionic conductivity, and phase purity are achieved by optimizing electrical currents, voltages, and electromagnetic energy.

The liquid-based synthesis methods include sol-gel, coprecipitation, and solution- or evaporation induced self-assembly. Compared to solid-based synthesis methods, the liquid-based synthesis methods require lower heat-treatment temperatures and can achieve better particle size and morphology of solid electrolytes. In such methods, a colloidal solution is formed using a solvent intermediate and then a gel network, followed by heat treatment for crystallization. The sol-gel method provides an effective pathway for high-purity crystalline solid electrolytes at lower heat-treatment temperature.

The coprecipitation method usually involves the dissolution of salt compounds of two desired precursors in the aqueous solution, followed by precipitation upon pH adjustment. The co-precipitate is freeze-dried and undergoes intermediate- to high-temperature calcination to achieve crystalline solid electrolytes. The sintering temperature and holding time play a very important role in the formation of high phase purity and ionic conductivity.

To reduce the cost of organic solvent and sintering temperature, solution-based synthesis is developed for LiCSSE and/or LiSICON solid electrolytes. The precursors are dissolved or suspended in water. The mixture is achieved by removing excess water, followed by heat treatment at relative low temperature (about 600° C. to about 800° C.). In addition, some venders, such as MTI corporation (Richmond, CA, US) and MSE Supplies LLC (Tucson, AZ, US), provide some small size LiSICON membranes. However, these commercial LiSICON membranes are high in price and lead to a high cost RFLE system.

In some embodiments, one or more dopants are added to the LiSICON membrane. The LiSICON dopants are not particularly limited but are in some embodiments selected from one or more dopants. Two doping approaches are known in the art and have been adopted: (1) doping at cation sites of hexahedron [TiO₆], and (2) doping at cation (P) or anion (O) sites of tetrahedron [PO₄]. The dopants at the cation sites of hexahedron [TiO₆] are not particularly limited but are in some embodiments selected from one or more of Ga³⁺, Sc³⁺, Y³⁺ Te⁴⁺, Sn⁴⁺ and Zr⁴⁺. (See, for instance, Kothari et al., Physica B: Condensed Matter, 501:90-94, 2016; Wang et al, Electrochimica Acta, 399:139367, 2021, Xu et. al, Nanomaterials, 12(12):2082, 2022; and Gan et al., Electrochimica Acta, 423:140567, 2022, all of which are incorporated herein by reference specifically for the disclosure and description of dopants utilized in LiSICON assembly).

Dopant cations having bigger radii enlarges the lattice parameters of crystal structures, which improves ion conductivity of LiSICON membranes. The substitutions of cation (P) or anion (0) sites in tetrahedron [PO₄] are not particularly limited but are in some embodiments selected from one or more of Si⁴⁺, V⁵⁺, Nb⁵⁺, S²⁻ and Cl⁻. (See, Liu et al., Journal of Alloys and Compounds, 756:103-110, 2018; Vijayan et al., Journal of Physics and Chemistry of Solids, 72(6):613-619, 2011; Chang et al., Journal of the American Ceramic Society, 88(7):1803-1807, 2005; Cai et al., Solid State Ionics, 354:115399, 2020; Li et al., Materials Chemistry Frontiers, 5(14):5336-5343, 2021; and Kizilaslan et al., Physical Chemistry Chemical Physics, 22(30):17221-17228, 2020, all of which are incorporated herein by reference specifically for the disclosure and description of dopants utilized in LiSICON assembly). The substitution of cation site (P) in the [PO₄] can increase the density during pellet or membranes sintering due to the formation of low melting oxides. In addition, the dopants in the anion site (0) of [PO₄] enhances the Li-ion transport in the grain boundaries because weaker electronegativity of doping anions compared to oxygen reduced the attraction of lithium ions.

### Anion Exchange Membranes (AEMs) and Electrodes

Particularly, it is noted that in some embodiments the anion exchange membranes (AEMs) comprise one or more of anion selective and commercially available materials, including, but not limited to, SELEMION™ AEMs (such as products named AMVN, DSVN and ASVN) developed by AGC Engineering (Chiba City, Chiba, Japan), NEOSEPTA AEMs (such as products named AFX, AHA, and AHO) fabricated by ASTOM Corporation (Ujitawara, Kyoto, Japan), Fumasep AEMs (such as products named FAA-3-20, FAP-330, FAPQ-330, FAB-PK-130, etc.) purchased from Fuel Cell Store (Bryan, Texas, USA). In some embodiments, the AEM material is as much as 90%, 92%, 94%, 96%, 98%, and even 99% or more selective towards chloride ion conduction. The Cl⁻ selectivity is easily evaluated using H-type diffusion cells by known methods, with the AEM separating a simulated brine and a blank solution, for example.

AEMs are commercially available in various forms and formats, in planar sheets of varying thicknesses and as conventional resins. The AEM is designed to be highly selective for negative ions, i.e., they bind to and assist in transport of monovalent anions across or through the membrane material, e.g., from one flow cell into another.

Electrodes are, in some embodiments, comprised of commercial carbon cloth, (Hydro-LAT-1400 and Hydro-LAT-2400 purchased from Fuel Cell Store, or CCP10 carbon cloth, such as those commercially available from Fuel Cell Earth (Woburn, MA, US), carbon paper (AvCarb EP40, AvCarb MGL 190 and AvCarb MGL 280, such as those commercially available from Full Cell Store (Woburn, MA, US) and graphite felts (SIGRACELL carbon and graphite felts, commercially available from SGL Carbon LLC (Wiesbaden, DE). In other embodiments, electrodes are comprised of one or more of carbon paper and graphite felts.

It is known that the morphology and surface chemistry of porous carbon electrodes largely affect electron transfer kinetics through tuning accessible redox sites, wettability, or electrocatalysis. Such morphology and surface chemistry can be varied to obtain optimum ASR in the RFLE. Thus, the morphology and surface chemistry or porousness of the electrode material is not particularly limited. The surface of the electrodes is in some embodiments functionalized by addition of, for example, heteroatoms and/or nanomaterials.

### Flow Cells

The size and shape of the flow cell is not particularly limited, but may be round, square, or any other shape. The flow cell may be flat or spherical or cuboid, or any other shape desired for the intended use. The main purpose of the flow cell is to allow a fluid stream containing ions and/or redox shuttle components to enter into the container so that they may make contact with one or more of the membranes, electrodes, and the like positioned within each flow cell, as described in further detail hereinbelow. After reaction therewith, the fluid is then allowed to flow out of the container through the outlet. Each flow cell may have one or more inlets and outlets, but will always have at least one inlet and at least one outlet. The size and shape of the inlets and outlets are not particularly limited but may be round or pipe-shaped, or any shape that efficiently allows passage of fluid through the container at a desired flow rate. The flow cell may optionally also comprise one or more controllers for controlling fluid flow through the inlet or the outlet at a desired flow rate. The flow cell may be comprised of any known materials such as plastics, metals, or other polymers and mixtures thereof known to be able to hold fluid without leakage. Further, the term “flow cell” is a generic term intended to encompass several different species of flow cell including, but not limited to, catholyte flow cell, anolyte flow cell, lithium base flow cell, brine water flow cell, and the like. In some instances, the flow cell will further comprise one or more electrodes.

Flow cells are interconnected by one or more fluid channels. Fluid channels are comprised of any known material such as metal, polymer, plastic, carbon fiber, and mixtures thereof.

At least one or more walls of the flow cells are comprised solely of an AEM or other membrane, such as an LiCSSE membrane, etc. That is, the flow cell is built such that it is liquid-tight except for one or more sides comprised of porous or semi-porous membranes that allow ions to pass therethrough from one flow cell to an adjacent flow cell. (See, FIG. 1A, FIG. 1B, and FIG. 1C, for example).

In some embodiments, the electrolytes flow rate in different flow cells are in the range from about 20 ml/min to about 100 ml/min. In some embodiments, the flow rate is from about 20 ml/min to about 30 ml/min, from about 20 ml/min to about 40 ml/min, from about 20 ml/min to about 50 ml/min, about 20 ml/min, about 30 ml/min, about 40 ml/min, about 50 ml/min, about 50 to about 100 ml/min, about 50 ml/min to about 60 ml/min, about 50 ml/min to about 70 ml/min, about 50 ml/min to about 80 ml/min, about 50 ml/min to about 90 ml/min, or from about 90 ml/min to about 100 ml/min.

Catholyte and anolyte flow cells described herein as components of the described systems are generally comprised of a graphite current collector and an electrode, where the redox shuttle electrolytes flow through and complete electrochemical reactions.

Lithium base and brine flow cells described herein as components of the described system are generally comprised of a flow chamber, which clamps a piece of LiCSSE and is separated by AEMs on the other side.

An exemplary RFLE is depicted in FIG. 1C. In this lithium extraction flow battery, the current collectors are made of graphite plates (Graphite Store, Northbrook, IL, US). Polytetrafluoroethylene (PTFE) gaskets (Equalseal, Warren, OH, US) are used as frames for the electrode. The lithium base flow cell and lithium brine flow cell are made of commercial plastic plates, such as polypropylene (PP), polyvinyl chloride (PVC) and polyether ether ketone (PEEK), which are commercially available from McMaster-Carr (Elmhurst, IL, US) and Boedeker Plastics (Shriner, TX, US).

### RFLE Performance Metrics

Methods using these described RFLE systems produce purified lithium ion fluid, or lithium-rich fluid, that is as much as about 95%, about 96%, about 98%, and about 99% or more pure LiCl, LiOH, or lithium metal. Purity is easily determined by known methodologies such as inductively-coupled plasma-mass spectroscopy (ICP-MS). In some embodiments, additional purification methods are employed to the lithium-rich fluid obtained from the outlets to further improve purity of chloride ion selection, such as size exclusion-based membrane engineering, e.g., incorporation of silica-based fillers to shrink the ion transport channel size. (See, for instance, Zhang et al., Energ. Environ. Sci., 5:6299-6303, doi:10.1039/c1ee02571f, 2012).

The lithium extraction rate (LER) and specific energy consumption (SEC) of the described RFLE systems mainly depend on the current density. The higher charging current density results in higher LER and more SEC. At the current density ranging from 1 mA/cm² to 100 mA/cm², the RFLE systems described herein achieve equal to or greater than about 1.5 to 150 mg_{LiCl}/(cm²·h) and SEC of equal to or more than 0.06 to 5 kWh·kg⁻¹_{LiCl}, and greater than about 99% LiCl, LiOH, or Li metal product purity are achieved by the described RFLE systems.

Further modifications and alternative embodiments of various aspects of the methods and systems described herein will be apparent to those skilled in the art in view of this description. Accordingly, this description is to be construed as illustrative only and is for the purpose of teaching those skilled in the art the general manner of carrying out the disclosed methods and systems. It is to be understood that the forms of the disclosed methods and systems shown and described herein are to be taken as examples of embodiments. Elements and materials may be substituted for those illustrated and described herein, parts and processes may be reversed, and certain features of the disclosed methods and systems are capable of being utilized independently, all as would be apparent to one skilled in the art after having the benefit of this description of the disclosed methods and systems. Changes may be made in the elements described herein without departing from the spirit and scope of the disclosed methods and systems as described in the following claims.

All of the references cited above, as well as all references cited herein, are incorporated herein by reference in their entireties. The following examples are offered by way of illustration and not by way of limitation. The experimental results obtained on the membrane and electrochemical cells provided below show the promising characteristics of RFLE systems for DLE. The high selectivity of the membrane and flow cell design have paved the way for substantial performance metrics for the RFLE, especially the extraction rate, energy consumption, and product purity.

### EXAMPLES

### Example 1: Sandwich-Structure LiSICON Membrane Fabrication

Sandwiched porous/dense/porous trilayer structures were fabricated for Li_{1.3}Al_{0.3}Ti_{1.7}(PO₄)₃ (LATP) membranes to provide enhanced conductivity while maintaining the mechanical strength of the LiSICON structures. The trilayer LATP membranes were fabricated via the following three steps.

The first step is the synthesis of LATP electrolyte. The LATP solid electrolyte (Li_{1.3}Al_{0.3}Ti_{1.7}(PO₄)₃) was prepared by solid-state method. Stoichiometric amounts of Li₂CO₃, TiO₂, (NH₄)₂H(PO₄)₃, and Al₂O₃ were mixed and ground for 1 hour in an agate mortar. The mixture was heated at 800° C. for 24 hours at 5° C./min. Then the heated mixture was ball-milled at 350 rpm for 3 hours.

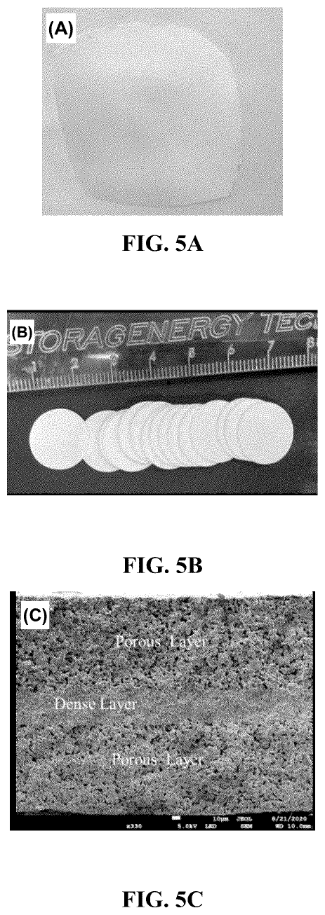

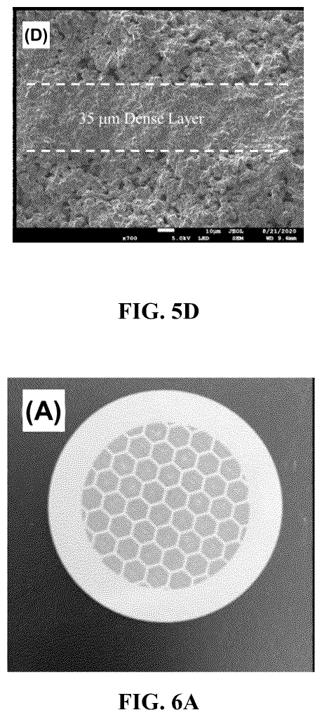

The second step comprises fabrication of dense layers and porous layers by tape casting. The tape slurry for the dense layers was prepared by blending LATP powder (40 wt %), dispersant (Menhaden fish oil, 0.2 wt %), binder (polyvinyl butyral, 7.4 wt %) and plasticizer (Benzyl butyl phthalate, 7.4 wt %) in ethanol/toluene (5/1, vol), followed by mixing in a Thinky planetary centrifugal bubble free mixer (Thinky USA, Laguna Hills, CA, US) at 2000 rpm for 5 minutes. The slurry was cast onto a dust-free silicone-coated polyethylene terephthalate (SiPET) carrier film after degassing under vacuum for 10 minutes. The doctor blade gap was set to 150 m. The cast membrane was dried overnight at room temperature. The tape was removed from the carrier film (the thickness of dried tape is around 35 m, see FIG. 5A). The tape slurry for porous layer was prepared by blending LATP powder (35 wt %), dispersant (Menhaden fish oil, 0.2 wt %), binder (polyvinyl butyral, 6.4 wt %), plasticizer (benzyl butyl phthalate, 6.4 wt %) and pore induce agent (cellulose, 10.8 wt %) in ethanol/toluene (5/1, vol), followed by mixing in a Thinky planetary centrifugal mixer (Thinky USA, Laguna Hills, CA, US) at 2000 rpm for 5 minutes. The slurry was cast onto a dust-free silicone-coated polyethylene terephthalate (SiPET) carrier film after degassing under vacuum for 10 minutes. The doctor blade gap was set at 600 m. The cast membrane was dried overnight at room temperature. The tape was removed from the carrier film (the thickness of dried tape is about 210 m).

The third step is treatment by hot-pressure and sintering. In the hot-pressure process, the tapes were clamped between two pieces of mylar sheets. The porous tape was hot pressured at 70° C. under 1000 pounds for 30 seconds, followed by hot-pressing at 70° C. under 5 tons for 10 min. The hot-pressed porous tape was then cut in half. The dense tape with the same size as the cut porous tape was put onto the top of the hot-pressed porous tape. These two tapes were then hot-pressed at 70° C. under 1000 pounds for 30 seconds, followed by further hot-pressure treatment at 70° C. under 5 tons for 10 min. The other porous tape was put onto the surface of the pressed porous/dense tape. A similar hot-pressure process was completed at 70° C. under 1000 pounds for 30 seconds, followed by hot-pressing at 70° C. under 5 tons for 10 min. The trilayer tape was then sintered at 1000° C. for at least 24 hours. The porosity of porous layer is around 45% (vol). The porosity of porous layers is tunable by increasing the amount of pore inducing agent. The porosity of the porous layer is in the range from 15% to 65% (vol).

The different size membranes are cut using laser cuter at RT. Disc membranes were laser-cut, and are shown in FIG. 5B. Cross sectional imaging was performed by scanning electron microscopy (SEM), and the resultant images are shown in FIG. 5C and FIG. 5D. In these figures, the sandwich structure is clearly visible, exhibiting a sharp contrast between the porous and the dense LiSICON layers. Dense layers as thin as 35 microns were achieved.

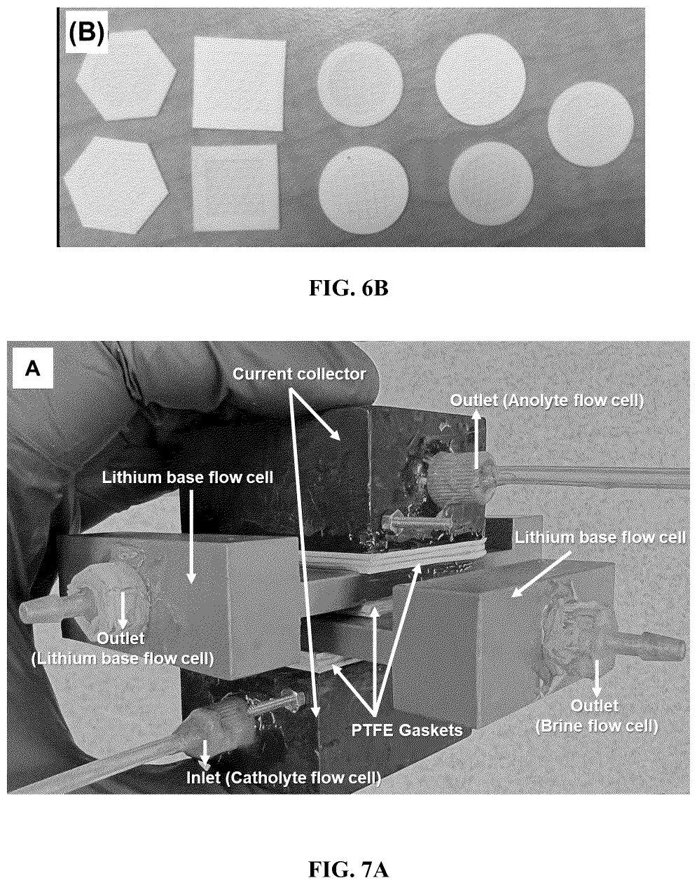

Additional sandwich structures were also made by laser etching as shown in FIG. 6A. In this process, a sandwich membrane was fabricated by laser etching a self-supported tape membrane. The self-supported tape membrane was fabricated by the following process. The LATP solid electrolyte (Li_{1.3}Al_{0.3}Ti_{1.7}(PO₄)₃) was prepared by solid-state method. Stoichiometric amounts of Li₂CO₃, TiO₂, (NH₄)₂H(PO₄)₃, and Al₂O₃ were mixed and ground for 1 hour in an agate mortar. The mixture was heated at 800° C. for 24 hours at 5° C./min, then the heated mixture was ball-milled at 350 rpm for 3 hours.

The LATP membrane was fabricated using a tape casting method. The tape slurry was prepared by blending LATP powder (70 wt %), dispersant (Menhaden fish oil, 0.5 wt %), binder (polyvinyl butyral, 14.75 wt %), and plasticizer (benzyl butyl phthalate, 14.75 wt %) in ethanol/toluene (5/1, vol), followed by mixing using a Thinky planetary centrifugal mixer (Thinky USA, Laguna Hills, CA, US) at 2000 rpm for 5 minutes. The slurry was cast onto a dust-free silicone-coated polyethylene terephthalate (SiPET) carrier film after degassing under vacuum for 10 minutes. The doctor blade gap was set to 1200 m. The cast membrane was dried overnight at room temperature. The tape was removed from the carrier film and cut into different shapes. The self-supported tape membrane was etched using laser-cuter (PLA 6.75 mode, Universal Laser Systems, Scottsdale, AZ, US). The maximum laser power was 15 W. The laser pulse per inch was 500, and the etching speed was about 0.1 mm/min to 1 mm/min. The etched self-supported tape membrane was then sintered at 450° C. for 3 hours, followed by sintering heat treatment at 950° C. for 3 hours.

The self-supported structures essentially start with a relatively thick, dense LiSICON green tape, and through various processes, portions of the membrane are removed through subtractive manufacturing techniques, leaving behind extremely thin regions of ceramic electrolyte material, supported by thicker veins of material. The etching feature of a laser cutting device allowed high precision in cut depth, providing membrane thicknesses down to 15 microns. Many geometries were tested, including honeycomb, triangular, and square grids as shown in FIG. 6B. The monolithic external annular rings will enhance the mechanical stability and ensure good sealing of the membranes during the flow cell assembly/testing. This process can be adapted to various other manufacturing processes, such as pressing or stamping, milling, or 3D printing. This flexibility adds to the practicality and scalability of the manufacture process.

### Example 2: Manufacture of Large Area LATP Membranes

In this example, large-area LATP membranes were manufactured by a solid state method. The stoichiometric amounts of Li₂CO₃, TiO₂, (NH₄)₂H(PO₄)₃ and Al₂O₃ were mixed and ground for 1 hour in an agate mortar. The mixture was heated at 800° C. for 24 hours at 5° C./min, then the heated mixture was ball-milled at 350 rpm for 3 hours. The LATP membrane was fabricated by the tape casting method. The tape slurry was prepared by blending LATP powder (70 wt %), dispersant (Menhaden fish oil, 0.5 wt %), binder (polyvinyl butyral, 14.75 wt %) and plasticizer (benzyl butyl phthalate, 14.75 wt %) in ethanol/toluene (5/1, vol.), followed by Thinky mixer (Thinky USA, Laguna Hills, CA, US) at 2000 rpm for 5 minutes. The slurry was cast onto a dust-free silicone-coated polyethylene terephthalate (SiPET) carrier film after degassing under vacuum for 10 minutes. The doctor blade gap was set to 800 m. The casted membrane was dried overnight at room temperature. The tape was removed from the carrier film and cut into cycle shape with 1 inch diameter. The cycle membranes were sintered at 450° C. for 3 hours, followed by sintering heat treatment at 950° C. for 3 hours. At last, the LATP membrane was polished down to a thickness of 300 m.

### Example 3: RFLE Design Fabrication, and Testing

Provided in this example is proof-of-concept data showing successful validation of the feasibility of the RFLE design at a small scale with LZSP membranes.

The LZSP solid electrolyte (Li₃Zr₂Si₂PO₁₂) was prepared by a solid-state method. Stoichiometric amounts of Li₂CO₃, ZrO₂, (NH₄)₂H(PO₄)₃ and SiO₂ were mixed and ground for 1 hour in an agate mortar. The mixture was firstly heated to 500° C. at 5° C./min and maintained at that temperature for 3 hours, then the temperature was increased to 1100° C. at a rate of 5° C./min and maintained at that temperature for 3 hours. The heated mixture was ball-milled at 350 rpm for 3 hours.

The LZSP membrane was then fabricated by a tape casting method. The tape slurry was prepared by blending LZSP powder (70 wt %), dispersant (Menhaden fish oil, 0.5 wt %), binder (polyvinyl butyral, 14.75 wt %) and plasticizer (benzyl butyl phthalate, 14.75 wt %) in ethanol/toluene (5/1, vol), followed by ball-milling at 300 rpm for 30 minutes. The slurry was cast onto a dust-free silicone-coated polyethylene terephthalate (SiPET) carrier film after degassing under vacuum for 10 minutes. The doctor blade gap was set to 800 m. The casted membrane was dried overnight at room temperature. The tape was removed from the carrier film and cut into cycle shape with 1 inch diameter. The cycle membranes were sintered at 600° C. for 3 hours, followed by sintering heat treatment at 1200° C. for 3 hours. At last, the LZSP membrane was polished down to a thickness of 300 m.

Instead of the traditional compressive bolt fastening used for redox flow batteries, an epoxy adhesive was used to glue the cell parts together and provide leak-free sealing. This sealing method eliminates the need of high mechanical compression forces and allows for a reliable assembly of the brittle LiSICON separator in RFLE cells. FIG. 7A shows such an assembled RFLE cell with an active area of 1.6 cm². The identities of the four flow channels are indicated. In initial RFLE tests, a 300 m-thick Li₃Zr_{2-y}Si_{2-4 y}P_{1+4y}O₁₂ (LZSP) separator and two SELEMION® ASVN AEMs were used; the former has an exclusive Li+ selectivity and the latter has good monovalent anion selectivity.

A large volume (4 L) of a simulated brine containing 30 mM LiCl, 2.2 M NaCl, and 0.36 M KCl was circulated through its channel. The LiCl influent was started with a base concentration of 0.05 M and a small volume of 20 mL. The RS electrolyte contained 0.05 M FcNCl/FcNCl⁺ at 50% SOC, and SGL graphite felt electrodes were used. An area specific ohmic resistance of 190 Ω·cm² was measured by electrochemical impedance spectroscopy (EIS) before Li extraction. The RFLE cell was tested at a series of constant current densities from 1 to 5 mA/cm² for a total of 10 hours (each current density for 2 hours). After the test, the LZSP remained structurally stable without any fracturing signs. (See, FIG. 7B, and FIG. 7C). The ASOR of RFLE cell decreased to 114 Ω·cm² because increasing LiCl concentration in Li base flow cell reduce ohmic impedance of RFLE cell. Crossover of FcNCl through the ASVNs was not observed, but water transport to the LiCl product stream occurred. The obtained voltage profile is plotted in FIG. 7D, showing relatively low average cell overpotentials of 0.17 V, 0.35 V, 0.51 V, 0.65 V, and 0.77 V, respectively, at these current densities in the symmetric cell operation. At 5 mA/cm², the RFLE cell demonstrated a LER of 7.9 mg_{LiCl}/(cm²·h) (vs. 0.35 mg_{LiCl}/(cm²·h), see Yanget at, Joule, 2(9):1648-1651, 2018) and a SEC of 0.49 kWh/kg_{LiCl} (vs. 6 to 21 kWh/kg_{LiCl}, see, Li et at, Journal of Membrane Science, 591:117317, 2019). (See, FIG. 7E). Impressively, even under the unoptimized conditions, such performance metrics are greater than 10-fold.

### Example 4: Lithium Extraction in an LEFB

The lithium single ion conduction membrane, such as LiSICON-type solid-state electrolyte membrane (Li₁₊ₓAl_{y}Ge_{2-y}(PO₄)₃ (LAGP) is one of the most commonly employed technologies for lithium extraction from seawater or brine. However, the high cost of Germanium (Ge) increases the total cost of the extraction process. However, Li₁₊ₓAlₓTi₂₋ₓ(PO₄)₃ (0.3≤x≤0.5, LATP) exhibited instability in aqueous electrolytes, where the LATP membranes were pulverized into powder during lithium ion extraction. In the prior experiment, Example 3, the Li₃Zr_{2-y}Si_{2-4y}P_{1+4y}O₁₂, (0≤y≤0.5, LZSP) showed outstanding stability in aqueous electrolyte, even though more electrolytes were permeated into the Li-lean tank. In this experiment, the composition of LZSP is further optimized and tested for performance in lithium extraction in a model flow battery. Here, the effect of redoxmer electrolyte concentration and flow rate on the lithium extraction flow battery performance was investigated.

As presented in FIG. 1A, FIG. 1B, and FIG. 1C, lithium ions can be recovered from seawater or brine through electrochemical reaction using the described RFLE systems and methodologies. The concentration of redox shuttle electrolytes affects the total impedance of lithium extraction flow batteries (LEFBs) and electrochemical processes. In LEFBs with low concentration of redox shuttle electrolyte, low flow rate may result in higher electrochemical polarization at high current densities. Meanwhile, higher flow rate may lead to electrolyte leaking owing to possible interstice among different battery parts.

To simulate natural brine and reduce electrolyte impedance, an artificial brine with LiCl, NaCl, and KCl (see Table 1) and 0.2 LiCl electrolyte were used as brine and lithium-lean electrolyte in LEFBs, which was used to balance the concentration of different ions. One piece of LZSP was clamped with two flow chambers and sandwiched by two pieces of commercial ASV-N anion exchange membranes. The effective electrode area of 1.6 cm² was used as electrode.

TABLE 1

| Artificial brine | Li⁺ | Na⁺ | K⁺ | Cl⁻ |
|---|---|---|---|---|
| Concentration | 211 | 52000 | 14000 | 93963 |
| (mg L⁻¹) | | | | |

FIG. 8 shows the different charge profiles of the LEFB with 0.05 mol/L FcNCl and 0.15 mol/L NaCl at the flow rates of 40 mL/min and 60 mL/min. The LEFB was charged for 2 hours at each current density. The increasing current density resulted in higher cell potential. Compared to the low flow rate of 40 mL/min, the high flow rate of 60 mL/min facilitates the mass transfer process and reduces the cell ohmic and charge transfer impedances, resulting in lower cell potential. Especially, the notable difference in cell potential is observed at high current density.

Optimal flow rate improves LEFB performance through accelerating mass transfer on the surface of electrodes, especially in the case of low concentration electrolyte. The LEFB performance was evaluated at different flow rates between 40 mL/min and 60 mL/min. As shown in FIG. 8, when 50% SOC electrolyte with 50 mmol/L FcNCl and 0.15 mol/L NaCl was used as the redox shuttle electrolyte, the LEFB under 40 mL per min flow rate exhibited similar cell voltage to that under 60 mL per min flow rate at current densities from 1 mA/cm² to 6 mA/cm², which suggested that the overpotential and polarization do not change with changing flow rates.

The cell voltage started to drastically increase at high current densities (more than 8 mA/cm²). Different from the initial color of redox shuttle electrolyte in LEFB, the color of redox shuttle electrolyte turned to light yellow from dark green after charging, which indicated the SOC of electrolyte differed from a pristine electrolyte of 50% SOC. Without wishing to be bound by any specific theory, it is postulated that perhaps the increase in cell voltage results from electrolyte SOC change. Additionally, the higher flow rate raises the possibility of the formation of interstices among different battery parts, which may result in some internal side reactions between the epoxy glue and redox shuttle solution.

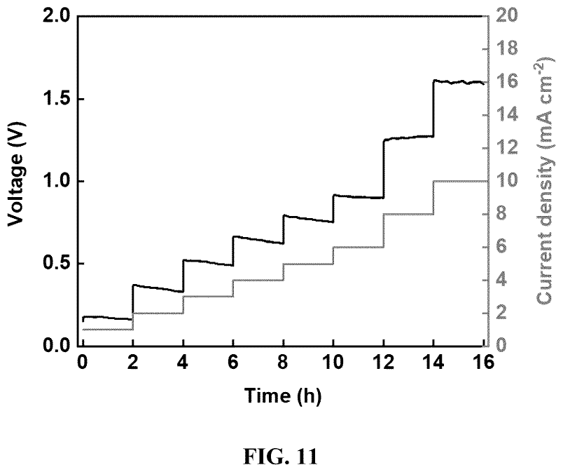

FIG. 11 shows the charge profiles of an LEFB with 0.05 mol/L FcNCl and 0.15 mol/L NaCl at different current densities ranging from 1 mA/cm² to 10 mA/cm². The Li recovery process was charged for 2 hours at each current density. With current density increasing, higher cell potentials were observed owing to higher overpotential. At 1 mA/cm², the initial cell potential was only 0.175 V. At high current density of 10 mA/cm², the initial cell potential increased to around 1.60 V. The charging voltage profiles tended to decrease with charging time, suggesting that the cell impedance was decreased due to increasing ion concentration in lithium-lean electrolyte. The charging voltage notably jumped to about 1.23 V at 8 mA/cm² and about 1.60 V at 10 mA/cm², where the voltage charging was significantly higher than that at low current densities from 1 mA/cm² to 6 mA/cm².

These results may be ascribed to higher concentration polarization at high current density. To minimize the influence of concentration polarization on LEFB performance, higher concentration redox shuttle electrolyte was employed in flow battery test.

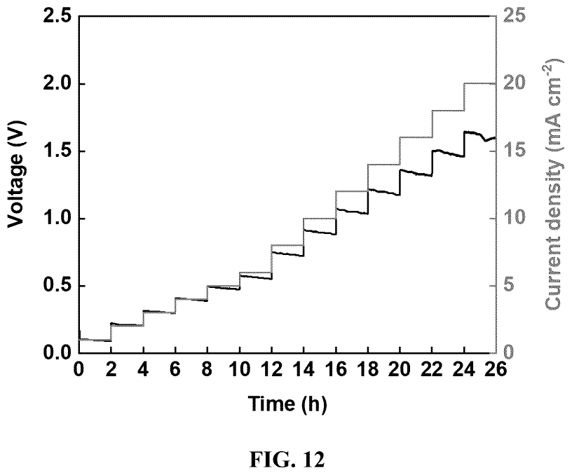

As shown in FIG. 12, lower cell potentials were observed in the LEFB with 0.2 mol/L FcNCl electrolyte. To inhibit contamination of NaCl in the redox shuttle electrolyte, the higher concentration FcNCl is used as the redox shuttle electrolyte in this experiment. The stable initial cell voltage was only 0.103 V at 1 mA/cm². Even at the high current density of 10 mA/cm², the initial voltage of LEFB was around 0.91 V, which was nearly two time lower than that of flow battery using low concentration redox shuttle electrolyte. This result may be explained by low overpotential and polarization. Therefore, when the current density was increased to 20 mA/cm², an initial voltage of about 1.64 V was obtained.

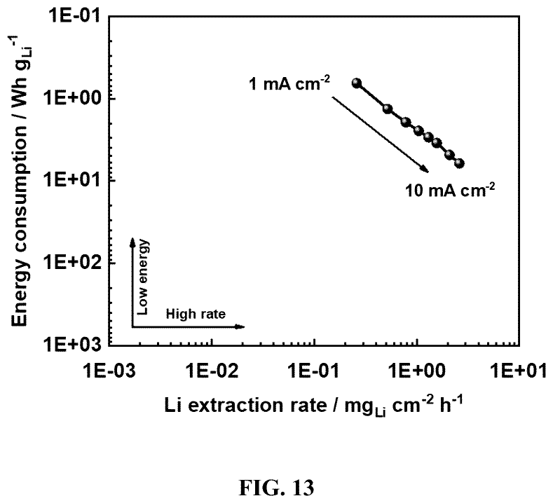

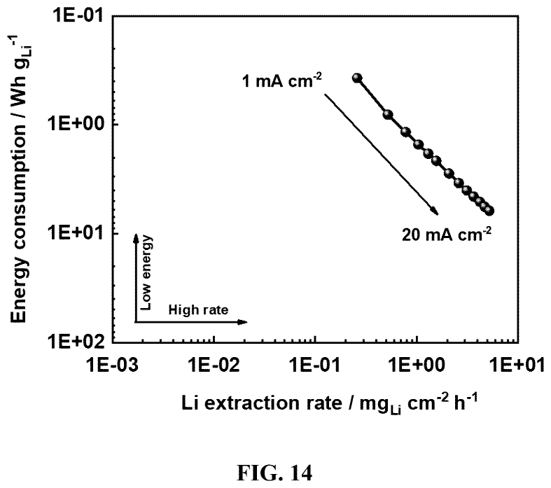

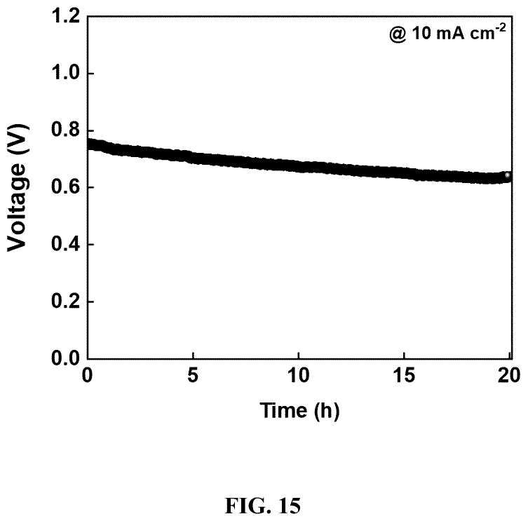

Higher current density for the LEFB test is beneficial to increase lithium extraction rate. Therefore, based on the LEFBs performance of different electrolytes, the energy consumption and lithium extraction rate were further analyzed. The trade-off between energy consumption and lithium extraction rate was presented in FIG. 13 and FIG. 14. The energy consumption of 0.65 Wh/g_{L}, and a lithium extraction rate of 0.26 mg_{L},/(cm²·h) were observed at 1 mA cm⁻², which was much lower than that reported in Wang et al., ACS Energy Lett., 7:3539-3544, 2022 (energy consumption of 2.5 Wh/g_{Li} and Li extraction rate of 0.04 mg_{Li}/(cm²·h)). With the current density increasing, the lithium extraction rate tended to increase, while the energy consumption gradually rose. Meanwhile, compared with the flow battery performance using 0.05 mol/L FcNCl electrolyte, the flow battery with 0.2 mol/L FcNCl electrolyte showed low energy consumption and faster Li extraction rate, implying that the electrochemical concentration polarization played a very important role in improving LEFB performance. At 10 mA/cm², the LEFB can stably charge for over 20 hours, indicating good stability in aqueous solution. (See, FIG. 15).

The breadth and scope of the present disclosure should not be limited by any of the above-described exemplary embodiments, but should be defined only in accordance with the following claims and their equivalents. That is, the above examples are included to demonstrate various exemplary embodiments of the described methods and systems. It will be appreciated by those of skill in the art that the techniques disclosed in the examples represent techniques discovered by the inventor to function well in the practice of the described methods and systems, and thus can be considered to constitute optional or exemplary modes for its practice. However, those of skill in the art will, in light of the present disclosure, appreciate that many changes can be made in these specific embodiments that are disclosed and still obtain a like or similar result without departing from the spirit and scope of the described methods and systems.

1. A redox flow lithium extraction system for enriching lithium chloride (LiCl), which comprises:
a lithium-ion conducting solid-state electrolyte (LiCSSE) membrane, wherein the LiCSSE membrane is selective for lithium ions and consists essentially of ceramic,
a first anion exchange membrane (AEM) and a second AEM, and
four flow cells,
wherein:
the four flow cells comprise a catholyte flow cell, an anolyte flow cell, a lithium base flow cell, and a brine water flow cell,
the lithium base flow cell and brine water flow cell are fluidly connected to the LiCSSE membrane,
the lithium base flow cell is fluidly connected to the catholyte flow cell by the first AEM,
the brine water flow cell is fluidly connected to the anolyte flow cell by the second AEM,
the catholyte flow cell and the anolyte flow cell are fluidly connected to each other by one or more fluid channels such that a fluid is carried between the catholyte flow cell and the anolyte flow cell in a continuous circulating manner,
the catholyte flow cell and the anolyte flow cell each comprise an electrode,
the LiCSSE membrane is positioned between AEMs, separated on one side by the lithium base flow cell and on an opposite side the brine water flow cell,
the lithium base flow cell comprises an first inlet allowing a flow of lithium-lean base fluid into the lithium base flow cell and an first outlet allowing an outflow of a lithium-rich product from the lithium base flow cell, wherein concentration of lithium is lower in the lithium-lean base fluid than in the lithium-rich product,
the brine water flow cell comprises an second inlet allowing a flow of sea water or brine into the brine water flow cell and an second outlet allowing an outflow of waste water,
lithium ions are attracted by and pass through the LiCSSE membrane from the brine water flow cell and into the lithium base flow cell,
chloride ions are attracted by and pass through the first AEM from the catholyte flow cell into the lithium base flow cell,
chloride ions are attracted by and pass through the second AEM from the brine water flow cell into the anolyte flow cell,
the one or more fluid channels comprise a fluid comprising a redox shuttle molecule (RSM),
the RSM is 2,2,6,6-tetramethyl-1-piperidinyloxy (TEMPO),
the RSM undergoes electrochemical reduction reaction in the catholyte flow cell and undergoes electrochemical oxidation reaction in the anolyte flow cell, and
the system optionally comprises one or more fluid pumps positioned in line with the one or more fluid channels.

2-4. (canceled)

5. The system of claim 1, wherein the LiCSSE membrane is a Li⁺-selective brine-stable lithium superionic conductor (LiSICON) membrane.

6. The system of claim 5, wherein the LiSICON membrane comprises a tri-layer of porous/dense/porous layers in a sandwich structure.

7. The system of claim 1, wherein the lithium-rich product comprises lithium ion at about 99% or greater purity.

8. The system of claim 1, wherein the system is a first RFLE flow stack, and wherein the system additionally comprises one or more additional RFLE flow cell stacks that are fluidly connected in parallel to the first RFLE flow stack.

9. A redox flow lithium extraction system for enriching lithium hydroxide (LiOH·H₂O), which comprises:
a lithium ion conducting solid-state electrolyte (LiCSSE) membrane,
an anion exchange membrane (AEM), and
three flow cells,
wherein the three flow cells comprise an anolyte flow cell, a catholyte flow cell, and a brine water flow cell,
wherein the catholyte flow cell and brine water flow cell are fluidly connected to the LiCSSE membrane,
wherein the brine water flow cell and the anolyte flow cell are fluidly connected to the AEM,
wherein the anolyte flow cell and catholyte flow cell each comprise an electrode,
wherein the catholyte flow cell comprises an first inlet allowing a flow of lithium-lean base fluid into the catholyte flow cell and an first outlet allowing an outflow of a lithium-rich product from the catholyte flow cell, wherein the lithium-lean base fluid has a lower concentration of lithium as compared with the lithium-rich product,
wherein the brine water flow cell comprises an second inlet allowing a flow of sea water or brine into the brine water flow cell and an second outlet allowing an outflow of waste water,
wherein lithium ions are attracted by and pass through the LiCSSE membrane from the brine water flow cell and into the catholyte flow cell,
wherein chloride ions are attracted by and pass through the AEM from the brine water flow cell into the anolyte flow cell,
wherein one or more fluid channels continuously circulate fluid comprising a redox shuttle molecule (RSM) through the anolyte flow cell,
wherein the RSM undergoes electrochemical oxidation in the anolyte flow cell while simultaneously the RSM is elsewhere reduced in a further flow cell to regenerate the reduced RSM, and
wherein the system optionally comprises one or more fluid pumps positioned in line with the one or more fluid channels.

10. The system of claim 9, wherein the RSM is an organometallic molecule.

11. The system of claim 9, wherein the RSM comprises one or more of (ferrocenylmethyl) trimethylammonium chloride (FcNCl) molecule, 1,1′-bis[3-(trimethylammonio)propyl]ferrocene dichloride (BTMAP-Fc), and 2,2,6,6-tetramethyl-1-piperidinyloxy (TEMPO).

12. The system of claim 9, wherein the LiCSSE membrane comprises one or more of:
(i) Li_{1.3}Al_{0.3}Ti_{1.7}(PO₄)₃ (LATP), Li_{1+y}Zr₂(SiO₄)_{y}(PO₄)_{3-y} (LYTP), Li₃Zr_{2-y}Si_{2-4y}P_{1+4y}O₁₂ (LZSP), Li₁₊ₓYₓZr₁₋ₓ(PO₄)₃ (LYZP), Li_{1+x+y}Y_{X}Zr₂₋ₓ(SiO₄)_{y}(PO4)_{3-y} (LYZSP), (Li₁₊ₓAl_{y}Ge_{2-y}(PO₄)₃ (LAGP), Li_{1.5}Al_{0.5}Ge_{1.5}(PO₄)₃, and Li_{3.1}Zr_{1.95}Mg_{0.05}Si₂PO₁₂,
(ii) Li₃ₓA_{2/3-x}BO₃, wherein A is La, Na, K, Ca, Sr, or Ba, and wherein B is Ti, Sc, In, Al, Sm, Ga, Ti, Zr, Hf, Sn, Ge, Nb, or Ta,
(iii) Li₇₋ₓMₓLa₃Zr₂O₁₂, wherein M is Al, Ga, Fe, or Ge,
(iv) Li₇La₃₋ₓEₓZr₂O₁₂ wherein E is Sr or Y,
(v) Li₇La₃Zr₂₋ₓJₓO₁₂, wherein J is Ta, Te, Nb, Sb, W, Mo, Cr, or Ti,
(vi) Li₆P₁₋ₘWₘS₅X, wherein X is Br, Cl, or I; and wherein W is Si, Sb, or As,
(vii) Li₂QR_{y}, wherein Q is In, Y, Er, Zn, or Zr, and wherein R is Cl, Br, or I, or
(viii) Li₃OV, wherein V is Br or Cl, and
wherein x, y, and m each have a value of 0 to 1.

13. The system of claim 9, wherein the oxidized RSM is regenerated chemically or electrochemically in the further flow cell, and/or wherein the LiCSSE membrane is a Li⁺-selective brine-stable lithium superionic conductor (LiSICON) membrane.

14. (canceled)

15. The system of claim 13, wherein the LiSICON membrane comprises a tri-layer of porous/dense/porous layers in a sandwich structure.

16. The system of claim 13, wherein the oxidized RSM is regenerated chemically by a reducing agent comprising a saccharide selected from one or more of glucose and fructose.

17. The system of claim 13, wherein the oxidized RSM is regenerated electrochemically in the further flow cell which comprises FeCl₂.

18. The system of claim 9, wherein the system is a first RFLE flow stack, and wherein the system additionally comprises one or more additional RFLE flow cell stacks that are fluidly connected in parallel to the first RFLE flow stack.

19. A redox flow lithium extraction system for enriching lithium metal (s), which comprises:
a lithium ion conducting solid-state electrolyte (LiCSSE) membrane,
an anion exchange membrane (AEM), and
three flow cells,
wherein the three flow cells comprise an anolyte flow cell, a catholyte flow cell, and a brine water flow cell,
wherein the catholyte flow cell and brine water flow cell are fluidly connected to the LiCSSE membrane,
wherein the brine water flow cell and the anolyte flow cell are fluidly connected to the AEM,
wherein the anolyte flow cell and the catholyte flow cell each comprises an electrode,
wherein the catholyte flow cell comprises an first inlet allowing a flow of lithium organic electrolyte fluid into the catholyte flow cell and an first outlet allowing an outflow of a lithium organic electrolyte from the catholyte flow cell,
wherein the electrode in the catholyte flow cell attracts deposits of lithium metal during operation of the system,
wherein the brine water flow cell comprises an second inlet allowing a flow of sea water or brine into the brine water flow cell and an second outlet allowing an outflow of waste water,
wherein lithium ions are attracted by and pass through the LiCSSE membrane from the brine water flow cell and into the catholyte flow cell,
wherein chloride ions are attracted by and pass through the AEM from the brine water flow cell into the anolyte flow cell,
wherein one or more fluid channels continuously circulate fluid comprising a redox shuttle molecule (RSM) through the anolyte flow cell,
wherein the RSM undergoes electrochemical oxidation in the anolyte flow cell while simultaneously is elsewhere reduced in a further flow cell to regenerate the reduced RSM, and
wherein the system optionally comprises one or more fluid pumps positioned in line with the one or more fluid channels.

20. The system of claim 19, wherein the RSM is an organometallic molecule.

21. The system of claim 19, wherein the RSM comprises one or more of (ferrocenylmethyl) trimethylammonium chloride (FcNCl) molecule, 1,1′-bis[3-(trimethylammonio)propyl]ferrocene dichloride (BTMAP-Fc), and 2,2,6,6-tetramethyl-1-piperidinyloxy (TEMPO).

22. The system of claim 19, wherein the LiCSSE membrane comprises one or more of:
(i) Li_{1.3}Al_{0.3}Ti_{1.7}(PO₄)₃ (LATP), Li_{1+y}Zr₂(SiO₄)_{y}(PO₄)_{3-y} (LYTP), Li₃Zr_{2-y}Si_{2-4y}P_{1+4y}O₁₂ (LZSP), Li₁₊ₓYₓZr₁₋ₓ(PO₄)₃ (LYZP), Li_{1+x+y}YₓZr₂₋ₓ(SiO₄)_{y}(PO4)_{3-y} (LYZSP), (Li₁₊ₓAl_{y}Ge_{2-y}(PO₄)₃ (LAGP), Li_{1.5}Al_{0.5}Ge_{1.5}(PO₄)₃, and Li_{3:1}Zr^{1.95}Mg_{0.05}Si₂PO₁₂,
(ii) Li₃ₓA_{2/3-x}BO₃, wherein A is La, Na, K, Ca, Sr, or Ba, and wherein B is Ti, Sc, In, Al, Sm, Ga, Ti, Zr, Hf, Sn, Ge, Nb, or Ta,
(iii) Li₇₋ₓMₓLa₃Zr₂O₁₂, wherein M is Al, Ga, Fe, or Ge,
(iv) Li₇La₃₋ₓEₓZr₂O₁₂ wherein E is Sr or Y,
(v) Li₇La₃Zr₂₋ₓJₓO₁₂, wherein J is Ta, Te, Nb, Sb, W, Mo, Cr, or Ti,
(vi) Li₆P₁₋ₘWₘS₅X, wherein X is Br, Cl, or I; and wherein W is Si, Sb, or As,
(vii) Li₂QR_{y}, wherein Q is In, Y, Er, Zn, or Zr, and wherein R is Cl, Br, or I, or
(viii) Li₃OV, wherein V is Br or Cl, and
wherein x, y, and m each have a value of 0 to 1.

23. The system of claim 19, wherein the oxidized RSM is regenerated chemically or electrochemically in the further flow cell, and/or wherein the LiCSSE membrane is a Li⁺-selective brine-stable lithium superionic conductor (LiSICON) membrane.

24. (canceled)

25. The system of claim 23, wherein the LiSICON membrane comprises a tri-layer of porous/dense/porous layers in a sandwich structure.

26. The system of claim 23, wherein the oxidized RSM is regenerated chemically by a reducing agent comprising a saccharide selected from one or more of glucose and fructose.

27. The system of claim 23, wherein the oxidized RSM is regenerated electrochemically in the further flow cell which comprises FeCl₂.

28. The system of claim 19, wherein the system is a first RFLE flow stack, and wherein the system additionally comprises one or more additional RFLE flow cell stacks that are fluidly connected in parallel to the first RFLE flow stack.

29. The system of claim 19, wherein the anolyte flow cell comprises a lithiophobic anode, and wherein the lithium metal (s) collects on the lithiophobic anode.

30. A method of extracting lithium from a fluid source, which comprises:
providing the system of claim 1,
pumping lithium-lean base fluid into the inlet of the lithium base flow cell,
pumping sea water or brine water into the brine water flow cell, and
circulating fluid from the anolyte flow cell to the catholyte flow cell and from the catholyte flow cell to the anolyte flow cell through the one or more flow channels attached to the anolyte flow cell and catholyte flow cell,
collecting lithium from the lithium-rich product from the first outlet and/or the second outlet,
wherein the fluid source is geothermal brine, brine water, or an aqueous solution comprising lithium.

31-32. (canceled)

33. The system of claim 1, wherein the LiCSSE membrane comprises one or more of:
(i) Li_{1+y}Zr₂(SiO₄)_{y}(PO₄)_{3-y}, Li₃Zr_{2-y}Si_{2-4y}P_{1+4y}O₁₂ (LZSP), Li₁₊ₓYₓZr₁₋ₓ(PO₄)₃ (LYZP), Li_{1+x+y}Y_{X}Zr₂₋ₓ(SiO₄)_{y}(PO4)_{3-y} (LYZSP), (Li₁₊ₓAl_{y}Ge_{2-y}(PO₄)₃ (LAGP), Li_{1.5}Al_{0.5}Ge_{1.5}(PO₄)₃, and Li_{3.1}Zr_{1.95}Mg_{0.05}Si₂PO₁₂,
(ii) Li₇₋ₓMₓLa₃Zr₂O₁₂; where M is Al, Ga, Fe, or Ge,
(iii) Li₇La₃₋ₓEₓZr₂O₁₂; where E is Sr or Y,
(iv) Li₆P₁₋ₘWₘS₅X, wherein X is Br, Cl, or I; where W is Si, Sb, or As,
(v) Li₂QR_{y}; where Q is In, Y, Er, Zn, or Zr; where R is Cl, Br, or I, or
(vi) Li₃OV; where V is Br or Cl, and
x, y, and m each have a value of 0 to 1.

34. A redox flow lithium extraction system for enriching lithium chloride (LiCl), which comprises:
a lithium-ion conducting solid-state electrolyte (LiCSSE) membrane, wherein the LiCSSE membrane is selective for lithium ions and consists essentially of ceramic,
a first anion exchange membrane (AEM) and a second AEM, and
four flow cells,
wherein:
the four flow cells comprise a catholyte flow cell, an anolyte flow cell, a lithium base flow cell, and a brine water flow cell,
the lithium base flow cell and brine water flow cell are fluidly connected to the LiCSSE membrane,
the lithium base flow cell is fluidly connected to the catholyte flow cell by the first AEM,
the brine water flow cell is fluidly connected to the anolyte flow cell by the second AEM,
the catholyte flow cell and the anolyte flow cell are fluidly connected to each other by one or more fluid channels such that a fluid is carried between the catholyte flow cell and the anolyte flow cell in a continuous circulating manner,
the catholyte flow cell and the anolyte flow cell each comprise an electrode,
the LiCSSE membrane is positioned between AEMs, separated on one side by the lithium base flow cell and on an opposite side the brine water flow cell,
the lithium base flow cell comprises an first inlet allowing a flow of lithium-lean base fluid into the lithium base flow cell and an first outlet allowing an outflow of a lithium-rich product from the lithium base flow cell, wherein concentration of lithium is lower in the lithium-lean base fluid than in the lithium-rich product,
the brine water flow cell comprises an second inlet allowing a flow of sea water or brine into the brine water flow cell and an second outlet allowing an outflow of waste water,
lithium ions are attracted by and pass through the LiCSSE membrane from the brine water flow cell and into the lithium base flow cell,
chloride ions are attracted by and pass through the first AEM from the catholyte flow cell into the lithium base flow cell,
chloride ions are attracted by and pass through the second AEM from the anolyte brine water flow cell into the anolyte flow cell,
the one or more fluid channels comprise a fluid comprising a redox shuttle molecule (RSM),
the RSM is 2,2,6,6-tetramethyl-1-piperidinyloxy (TEMPO),
the RSM undergoes electrochemical reduction reaction in the catholyte flow cell and undergoes electrochemical oxidation reaction in the anolyte flow cell,
the system optionally comprises one or more fluid pumps positioned in line with the one or more fluid channels,
the LiSICON membrane comprises a tri-layer of porous/dense/porous layers in a sandwich structure, and
the LiCSSE membrane comprises one or more of: Li_{1+y}Zr₂(SiO₄)_{y}(PO4)_{3-y}, Li₃Zr_{2-y}Si_{2-4 y}P_{1+4y}O₁₂ (LZSP), Li₁₊ₓYₓZr₁₋ₓ(PO₄)₃ (LYZP), Li_{1+x+y}Y_{X}Zr₂₋ₓ(SiO₄)_{y}(PO4)_{3-y} (LYZSP), Li_{1.5}Al_{0.5}Ge_{1.5}(PO₄)₃, Li_{3.1}Zr_{1.95}Mg_{0.05}Si₂PO₁₂, and Li₂QR_{y}, where Q is In, Y, Er, Zn, or Zr, and where R is Cl, Br, or I.
